(19) United States
(12) Patent Application Publication
(10) Pub. No.: US 2015/0002351 A1
(43) Pub. Date: Jan. 1, 2015

(54) SLOT ANTENNA WITH A COMBINED BANDPASS/BANDSTOP FILTER NETWORK

(71) Applicant: Research In Motion Limited, Waterloo (CA)

(72) Inventors: Seong Heon Jeong, Irving, TX (US); David Fisk, Bedford, TX (US)

(21) Appl. No.: 13/930,981

(22) Filed: Jun. 28, 2013

(51) Int. Cl. H01Q 13/10

(52) U.S. Cl. CPC H01Q 13/103
USPC 343/750; 343/749

(57) ABSTRACT

A slot antenna with a filter network is provided. The slot antenna is connectable to an antenna feed, and configured to resonate at a first frequency when surface current from the antenna feed flows around the slot antenna, the slot antenna comprising a first side and a second side separated by a width. A filter network bridges the first side and the second side, across the width, at a given position from a surface-current-originating end of slot antenna, the filter network configured to: electrically isolate the first side from the second side at the first frequency so that a length of the slot antenna defines a resonant length of the slot antenna at the first frequency; and, electrically connect the first side to the second side at a second frequency higher than the first frequency, so that the surface current flows across the filter network at the given position.

### FIELD

The specification relates generally to antennas, and specifically to a slot antenna with a combined bandpass/bandstop filter network.

### BACKGROUND

Current mobile electronic devices, such as smartphones, tablets and the like, generally have different antennas implemented to support different types of wireless protocols and/or to cover different frequency ranges. For example, LTE (Long Term Evolution) bands, GSM (Global System for Mobile Communications) bands, UMTS (Universal Mobile Telecommunications System) bands, and/or WLAN (wireless local area network) bands, cover frequency ranges from 700 to 960 MHz, 1710-2170 MHz, and 2500-2700 MHz and the specific channels within these bands can vary from region to region necessitating the use of different antennas for each region in similar models of devices. This can complicate both resourcing and managing the different antennas for devices in each region.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a schematic diagram of a device including an antenna with a combined bandpass/bandstop filter network, according to non-limiting implementations.

FIG. 2 depicts a schematic diagram of an antenna with a combined bandpass/bandstop filter network that can be used in the device of FIG. 1, according to non-limiting implementations.

FIG. 3 depicts a return-loss curve of the antenna of FIG. 2, and a return-loss curve of an equivalent monopole antenna without the bandpass/bandstop filter network, according to non-limiting implementations.

FIG. 4 depicts an input impedance curve of the antenna of FIG. 2, and an input impedance curve of an equivalent monopole antenna without the bandpass/bandstop filter network, according to non-limiting implementations.

FIG. 5 depicts transmission coefficients (i.e. S21) and reflection coefficients (i.e. S11) of the bandpass/bandstop filter network of FIG. 2, as well as transmission coefficients of only the bandpass filter for comparison, according to non-limiting implementations.

FIG. 6 depicts a return-loss curve of a successful prototype of the antenna of FIG. 2, and a return-loss curve of a prototype of an equivalent monopole antenna without the bandpass/bandstop filter network, according to non-limiting implementations.

FIG. 7 depicts three antennas that can be used in the device of FIG. 1, each of the antennas similar to the antenna of FIG. 2, but with a bandstop/bandpass filter network at different locations, according to non-limiting implementations.

FIG. 8 depicts a schematic diagram of an antenna, with two combined bandpass/bandstop filter networks that can be used in the device of FIG. 1, according to non-limiting implementations.

FIG. 9 depicts a schematic diagram of an antenna, with a combined bandpass/bandstop filter network, and an additional radiating arm, that can be used in the device of FIG. 1, according to non-limiting implementations.

FIG. 10 depicts a schematic diagram of an alternative antenna, with a combined bandpass/bandstop filter network, where radiating arms have different widths, which can be used in the device of FIG. 1, according to non-limiting implementations.

FIG. 11 depicts a schematic diagram of an alternative antenna, with a combined bandpass/bandstop filter network, where radiating arms have different widths, which can be used in the device of FIG. 1, according to non-limiting implementations.

FIG. 12 depicts a schematic diagram of an alternative antenna, with a combined bandpass/bandstop filter network, each of the bandstop filter and the bandpass filter comprising a respective tunable capacitor, which can be used in the device of FIG. 1, according to non-limiting implementations.

FIG. 13 depicts effect of tuning a tunable bandpass filter capacitor on transmission coefficients (i.e. S21) and reflection coefficients (i.e. S11) of the bandpass/bandstop filter network of FIG. 12, according to non-limiting implementations.

FIG. 14 depicts effect of tuning a tunable bandstop filter capacitor on transmission coefficients (i.e. S21) and reflection coefficients (i.e. S11) of the bandpass/bandstop filter network of FIG. 12, according to non-limiting implementations.

FIG. 15 depicts a schematic diagram of an alternative antenna with a combined bandpass/bandstop filter network with a tunable capacitor, which can be used in the device of FIG. 1, according to non-limiting implementations.

FIG. 16 depicts effect of tuning the capacitor of the bandpass/bandstop filter network of FIG. 15 on transmission coefficients (i.e. S21) and reflection coefficients (i.e. S11), according to non-limiting implementations.

FIG. 17 depicts a schematic diagram of a slot antenna with a filter network that can be used in the device of FIG. 1, according to non-limiting implementations.

FIG. 18 depicts the slot antenna of FIG. 17 with surface current flowing around the slot antenna at a first frequency, according to non-limiting implementations.

FIG. 19 depicts the slot antenna of FIG. 17 with surface current flowing across the filter network at a second frequency higher than the first frequency, according to non-limiting implementations.

FIG. 20 depicts a portion the slot antenna of FIG. 17 showing details of a filter network that includes a bandpass filter and a bandstop filter, according to non-limiting implementations.

FIG. 21 depicts transmission coefficients (i.e. S21) and reflection coefficients (i.e. S11) of the bandpass/bandstop filter network of FIG. 20, according to non-limiting implementations.

FIG. 22 depicts a schematic diagram of an alternative slot antenna with a tunable filter network, which can be used in the device of FIG. 1, according to non-limiting implementations.

FIG. 23 depicts a portion the slot antenna of FIG. 22 showing details of the filter network that includes a bandpass filter and a bandstop filter with a tunable capacitor, which can be used in the device of FIG. 1, according to non-limiting implementations.

FIG. 24 depicts a schematic diagram of an alternative slot antenna with two filter networks, which can be used in the device of FIG. 1, according to non-limiting implementations.

FIG. 25 depicts a schematic diagram of an alternative slot antenna with a tunable filter network, and one or more second slot antennas, which can be used in the device of FIG. 1, according to non-limiting implementations.

FIG. 26 depicts a return-loss curve of the slot antenna of FIG. 25, and a return-loss curve of an equivalent slot antenna without the filter network, according to non-limiting implementations.

### DETAILED DESCRIPTION

The present disclosure describes examples of an antenna with combined bandpass/bandstop filter networks that can resonate at two or more frequency responses to cover bands that include channels for LTE bands, GSM bands, UMTS bands, CDMA bands, GPS bands, and/or WLAN bands in a plurality of geographical regions.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

Furthermore, as will become apparent, in this specification certain elements may be described as connected physically, electrically, or any combination thereof, according to context. In general, components that are electrically connected are configured to communicate (that is, they are capable of communicating) by way of electric signals. According to context, two components that are physically coupled and/or physically connected may behave as a single element. In some cases, physically connected elements may be integrally formed, e.g., part of a single-piece article that may share structures and materials. In other cases, physically connected elements may comprise discrete components that may be fastened together in any fashion. Physical connections may also include a combination of discrete components fastened together, and components fashioned as a single piece.

An aspect of the specification provides an antenna comprising: a ground plane; a slot antenna in the ground plane, the slot antenna connectable to an antenna feed, and configured to resonate at a first frequency when surface current from the antenna feed flows around the slot antenna, the slot antenna comprising a first side and a second side separated by a width; and, a filter network bridging the first side and the second side, across the width, at a given position from a surface-current-originating end of slot antenna, the filter network configured to: electrically isolate the first side from the second side at the first frequency so that a length of the slot antenna defines a resonant length of the slot antenna at the first frequency; and, electrically connect the first side to the second side at a second frequency higher than the first frequency, so that the surface current flows across the filter network at the given position, thereby shortening the resonance length of the slot antenna and the slot antenna resonates at the second frequency.

The length of the slot antenna can corresponds to resonance at the first frequency.

A distance between the given position and the surface-current-originating end of the slot antenna can correspond to resonance at the second frequency.

The first frequency can be one or more of at about 700 MHz and between about 700 MHz to about 960 MHz.

The second frequency can be at about 850 MHz, between about 1710 to about 2170 MHz, or about 2500 to about 2700.

The filter network can comprise a bandpass filter and a bandstop filter. The bandpass filter can comprise a first inductor and a capacitor connected in parallel between the first side and the second side. The bandstop filter can comprise the capacitor and a second inductor connected in series with the capacitor. One or more of the bandstop filter and the bandpass filter can be tunable. One or more of the bandpass filter and the bandstop filter comprise at least one tunable capacitor. The antenna can further comprise: a directional coupler capacitively coupled to the slot antenna; and, a spectrum analyzer and microcontroller in communication with the directional coupler and the at least one tunable capacitor, the spectrum analyzer configured to determine an input frequency of the slot antenna and the microcontroller configured to tune the at least one tunable capacitor according to the input frequency.

The antenna can further comprise: at least a second filter network bridging the first side and the second side, across the width, at a second given position along the length, the second given position between the given position and the surface-current-originating end of the slot antenna, the second filter network configured to: electrically isolate the first side from the second side at the first frequency and the second frequency; and, electrically connect the first side to the second side at a third frequency higher than the second frequency, so that the surface current flows across the second filter network at the second given position, thereby further shortening the resonance length of the slot antenna so that the slot antenna resonates at the third frequency. The filter network can be further configured to electrically isolate the first side from the second side at the third frequency.

The antenna can further comprise one or more second slot antennas in communication with the slot antenna at surface-current-originating end of the slot antenna, the one or more second slot antennas configured to resonate at one or more third frequencies different from the first frequency and the second frequency. The one or more second slot antennas can have a different width from the slot antenna.

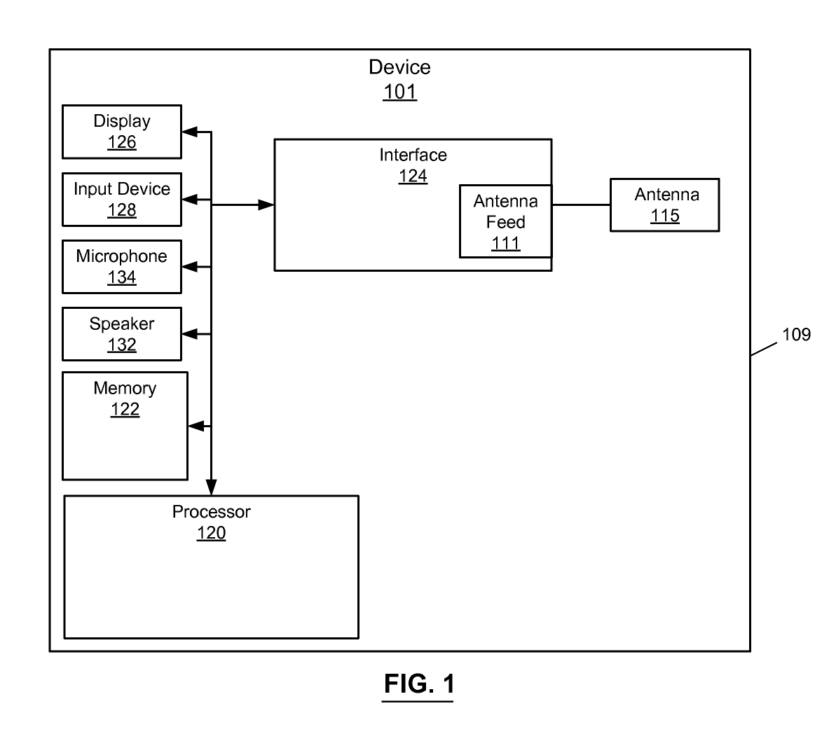

FIG. 1 depicts a schematic diagram of a mobile electronic device 101, referred to interchangeably hereafter as device 101, according to non-limiting implementations. Device 101 comprises: a chassis 109 comprising a ground plane; an antenna feed 111, and an antenna 115 with a combined bandpass/bandstop filter network connected to the antenna feed 111, described in further detail below. Device 101 can be any type of electronic device that can be used in a self-contained manner to communicate with one or more communication networks using antenna 115. Device 101 includes, but is not limited to, any suitable combination of electronic devices, communications devices, computing devices, personal computers, laptop computers, portable electronic devices, mobile computing devices, portable computing devices, tablet computing devices, laptop computing devices, desktop phones, telephones, PDAs (personal digital assistants), cellphones, smartphones, e-readers, internet-enabled appliances and the like. Other suitable devices are within the scope of present implementations. Device hence further comprise a processor 120, a memory 122, a display 126, a communication interface 124 that can optionally comprise antenna feed 111, at least one input device 128, a speaker 132 and a microphone 134. Processor 120 is also in communication with one or more switches of antenna 115, as described in further detail below.

It should be emphasized that the structure of device 101 in FIG. 1 is purely an example, and contemplates a device that can be used for both wireless voice (e.g. telephony) and wireless data communications (e.g. email, web browsing, text, and the like). However, FIG. 1 contemplates a device that can be used for any suitable specialized functions, including, but not limited, to one or more of, telephony, computing, appliance, and/or entertainment related functions.

Device 101 comprises at least one input device 128 generally configured to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

Input from input device 128 is received at processor 120 (which can be implemented as a plurality of processors, including but not limited to one or more central processors (CPUs)). Processor 120 is configured to communicate with a memory 122 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 101 as described herein are typically maintained, persistently, in memory 122 and used by processor 120 which makes appropriate utilization of volatile storage during the execution of such programming instructions. Those skilled in the art will now recognize that memory 122 is an example of computer readable media that can store programming instructions executable on processor 120. Furthermore, memory 122 is also an example of a memory unit and/or memory module.

Processor 120 can be further configured to communicate with display 126, and microphone 134 and speaker 132. Display 126 comprises any suitable one of, or combination of, CRT (cathode ray tube) and/or flat panel displays (e.g. LCD (liquid crystal display), plasma, OLED (organic light emitting diode), capacitive or resistive touchscreens, and the like). Microphone 134 comprises any suitable microphone for receiving sound and converting to audio data. Speaker 132 comprises any suitable speaker for converting audio data to sound to provide one or more of audible alerts, audible communications from remote communication devices, and the like. In some implementations, input device 128 and display 126 are external to device 101, with processor 120 in communication with each of input device 128 and display 126 via a suitable connection and/or link.

Processor 120 also connects to communication interface 124 (interchangeably referred to interchangeably as interface 124), which can be implemented as one or more radios and/or connectors and/or network adaptors, configured to wirelessly communicate with one or more communication networks (not depicted) via antenna 115. It will be appreciated that interface 124 is configured to correspond with network architecture that is used to implement one or more communication links to the one or more communication networks, including but not limited to any suitable combination of USB (universal serial bus) cables, serial cables, wireless links, cell-phone links, cellular network links (including but not limited to 2G, 2.5G, 3G, 4G+ such as UMTS (Universal Mobile Telecommunications System), GSM (Global System for Mobile Communications), CDMA (Code division multiple access), FDD (frequency division duplexing), LTE (Long Term Evolution), TDD (time division duplexing), TDD-LTE (TDD-Long Term Evolution), TD-SCDMA (Time Division Synchronous Code Division Multiple Access) and the like, wireless data, Bluetooth links, NFC (near field communication) links, WLAN (wireless local area network) links, WiFi links, WiMax links, packet based links, the Internet, analog networks, the PSTN (public switched telephone network), access points, and the like, and/or a combination.

Specifically, interface 124 comprises radio equipment (i.e. a radio transmitter and/or radio receiver) for receiving and transmitting signals using antenna 115. It is further appreciated that, as depicted, interface 124 comprises antenna feed 111, which alternatively can be separate from interface 124.

Device 101 further comprises a power source, not depicted, for example a battery or the like. In some implementations the power source can comprise a connection to a mains power supply and a power adaptor (e.g. and AC-to-DC (alternating current to direct current) adaptor).

Device 101 further comprises an outer housing which houses components of device 101, including chassis 109. Chassis 109 can be internal to the outer housing and be configured to provide structural integrity to device 101. Chassis 109 can be further configured to support components of device 101 attached thereto, for example, display 126. In specific implementations chassis 109 can comprise one or more of a conducting material and a conducting metal, such that chassis 109 forms a ground and/or a ground plane of device 101; in alternative implementations, at least a portion of chassis 109 can comprise one or more of a conductive covering and a conductive coating which forms the ground plane.

In any event, it should be understood that a wide variety of configurations for device 101 are contemplated.

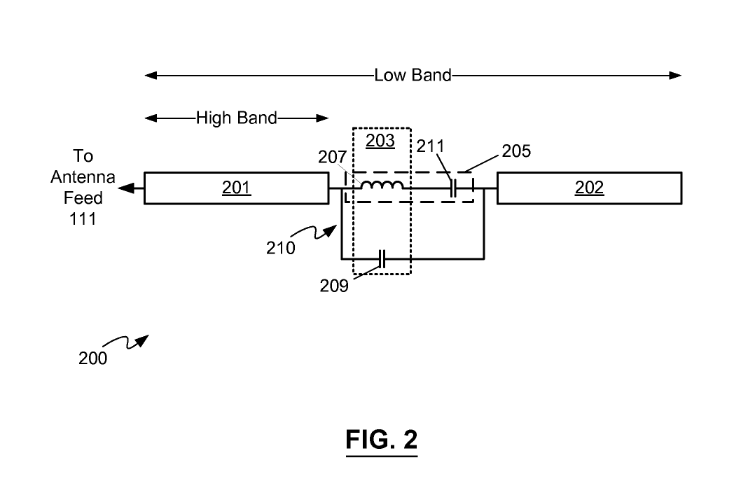

Antenna 115 can comprise a wide variety of configurations as described hereafter. For example, attention is next directed to FIG. 2, which depicts non-limiting implementations of an antenna 200. Antenna 115 can comprise antenna 200.

Antenna 200 comprises: a first radiating arm 201 connectable to antenna feed 111, first radiating arm 201 configured to resonate at a first frequency; a second radiating arm 202, second radiating arm 202 and first radiating arm 201, when electrically connected, configured to resonate at a second frequency lower than the first frequency; a filter network 210 comprising a bandstop filter 203 and a bandpass filter 205, filter network 210 filtering an electrical connection between first radiating arm 201 and second radiating arm 202, filter network 210 configured to: electrically isolate first radiating arm 201 from second radiating arm 202 at the first frequency, and electrically connect first radiating arm 201 and second radiating arm 202 at the second frequency. In some implementations, as depicted in FIG. 1, filter network 210 joins first radiating arm 201 to second radiating arm 202. Filter network 210 is generally configured to electrically isolate first radiating arm 201 and second radiating arm 202 at a same frequency corresponding to a resonance length defined by a length (labelled “High Band” in FIG. 2) of first radiating arm 201 and to electrically connect first radiating arm 201 and second radiating arm 202 at a frequency corresponding to a resonance length defined by a total length (labelled “Low Band” in FIG. 2) of first radiating arm 201 and second radiating arm 202.

First radiating arm 201 is generally connectable to antenna feed 111 using any suitable connector, including, but not limited to, wires, solder, plugs, electronic traces, and the like. Indeed, in some implementations first radiating arm 201 is hardwired to antenna feed 111. Indeed, antenna 200 can comprise a connector to antenna feed 111.

It is further appreciated that each of first radiating arm 201 and second radiating arm 202 comprise monopole antennas. For example, first radiating arm 201 has a length corresponding to resonance at the first frequency (the length labelled as “High Band” in FIG. 2); and first radiating arm 201 and the second radiating arm form a line and a total length of first radiating arm 201 and second radiating arm 202 corresponds to resonance at the second frequency (the total length labelled as “Low Band” in FIG. 2, and includes the area between first radiating arm 201 and second radiating arm 202, including bandstop filter 203 and bandpass filter 205). In other words, first radiating arm 201 and second radiating arm 202 behave as a single radiating arm, and/or a single monopole antenna of the “Low Band” length, at the second frequency. Filter network 210 isolates first radiating arm 201 from second radiating arm at the first frequency such that second radiating arm 202 does not contribute resonance at the first frequency, and first radiating arm 201 acts as a single monopole antenna at the first frequency, of the “High Band” length.

In other words, antenna 200 comprises at least two resonances, a first resonance at the first frequency that corresponds to first radiating arm 201, and a second resonance at a second frequency lower than the first frequency that corresponds to a resonance of a monopole antenna that is a size and/or length and/or shape of first radiating arm 201 combined with second radiating arm 202. Filter network 210 electrically isolates second radiating arm 202 from first radiating arm 201 at the higher first frequency, and electrically connects the first radiating arm 201 to second radiating arm 202 at the lower second frequency. As antenna 200 is being fed from antenna feed 111 via first radiating arm 201, second radiating arm 202 does not resonate in isolation from first radiating arm 201.

Further, in FIG. 2, a length of first radiating arm 201 is designated as “High Band” and a length of the combination of first radiating arm 201 and second radiating arm 202 is designated as “Low Band”, with the “Low Band” length being longer than the “High Band” length; hence, first radiating arm 201 will resonate at a higher frequency than the combination of first radiating arm 201 electrically connected to second radiating arm 202.

In general, a respective length and/or size and/or shape of each of first radiating arm 201 and second radiating arm 202 is chosen such that first radiating arm 201 and second radiating arm 202 to correspond with desired resonance frequencies. In specific non-limiting implementations, a length and/or size and/or shape of first radiating arm 201 is chosen so that first radiating arm 201 resonates between about 1800 MHz to about 1900 MHz. Put another way, first radiating arm 201 can be configured to resonate between about 1800 MHz to about 1900 MHz.

Similarly, a length and/or size and/or shape of second radiating arm 202 is chosen so that the combination of first radiating arm 201 and second radiating arm 202 resonates between about 850 MHz to about 900 MHz. Put another way, the combination of first radiating arm 201 electrically connected to second radiating arm 202 is configured to resonate between about 850 MHz to about 900 MHz.

The bands of about 1800 MHz to about 1900 MHz (e.g. the first frequency) and about 850 MHz to about 900 MHz (e.g. the second frequency) can be chosen as they correspond to bands in commercial networks, including, but not limited to GSM networks and 4G LTE networks, however other bands are within a scope of present implementations. For example, two frequency bands from 700 to 960 MHz, 1710-2170 MHz, and 2500-2700 MHz can be chosen to correspond with commercially used frequency bands.

Furthermore, while each of first radiating arm 201 and second radiating arm 202 are depicted as linear monopole antennas aligned along a longitudinal axis of antenna 200, in other implementations first radiating arm 201 and second radiating arm 202 can be arranged at angles to one another to shape a radiation pattern of antenna 200. Furthermore, one or more of first radiating arm 201 and second radiating arm 202 can comprise a shape more complex than the depicted linear monopole antenna, to shape a radiation pattern of antenna 200. In these implementations, it is appreciated that one or more of the “High Band” length and the “Low Band” length can comprise one or more of an electrical length and a resonant length rather than a physical length. Indeed, due to fringe effects that can occur with linear monopole antennas, the “High Band” length and the “Low Band” length can comprise one or more of an electrical length and a resonant length rather than a physical length even for first radiating arm 201 and second radiating arm 202 as depicted.

It is further appreciated that as frequency is being increased bandstop filter 203, the low frequency band is passed first and a high frequency band is stopped later. Hence bandstop filter 203 blocks the second frequency from reaching bandpass filter 205, thereby increasing the sharpness of the response of bandpass filter 205 and removing out-of-band resonances as described in further detail below.

Bandstop filter 203 and bandpass filter 205 can be combined in filter network 210, and furthermore can share components. For example, in specific non-limiting implementations, as depicted, bandstop filter 203 comprises an inductor 207 and a first capacitor 209 connected in parallel (and/or in shunt) between first radiating arm 201 and second radiating arm 202. It is further appreciated that components of bandstop filter 203 are indicated by a stippled box. Further, in the depicted specific non-limiting implementations, bandpass filter 205 comprises inductor 207 and a second capacitor 211 connected in series with inductor 207, second capacitor 211 located between inductor 207 and second radiating arm 202. Second capacitor 211 is also connected in parallel with first capacitor 209. It is further appreciated that components of bandpass filter 205 are also indicated by a stippled box different from the stippled box indicating bandstop filter 203.

In other words, first radiating arm 201, inductor 207, second capacitor 211 and second radiating arm 202 are connected in series, and in the recited order, inductor 207 electrically adjacent first radiating arm 201 and second capacitor 211 electrically adjacent second radiating arm 202.

In specific non-limiting implementations, inductor 207 has an inductance of about 22 nH, first capacitor 209 has a capacitance of about 0.15 pF, and second capacitor 211 has a capacitance of about 1.8 pF. These values enable this simply circuit to act as a short circuit between first radiating arm 201 and second radiating arm 202 in frequencies ranging from about 850 MHz to about 900 MHz, and as an open circuit from first radiating arm 201 to second radiating arm 202 in frequencies ranging from about 1800 MHz to about 1900 MHz.

However, values for each of inductor 207, first capacitor 209 and second capacitor 211 can be chosen such that bandstop frequencies and bandpass frequencies correspond with resonance frequencies of first radiating arm 201 and second radiating arm 202. In other words, length, and the like, of each of first radiating arm 201 and second radiating arm 202 and values for each of inductor 207, first capacitor 209 and second capacitor 211 are commensurate with each other.

Furthermore, while specific non-limiting implementations of circuits for bandstop filter 203 and bandpass filter 205 are depicted, in other implementations, other circuits for bandstop filter 203 and bandpass filter 205 can be used. For example, in some implementations, there is no overlap of components of bandstop filter 203 and bandpass filter 205. Further, additional components can be used to increase or decrease the sharpness of filtering of one or more of bandstop filter 203 and bandpass filter 205.

It is further appreciated that an input frequency from antenna feed 111 to antenna 200 can be controlled either by one or more of processor 120 and interface 124. In other words, as device 101 switches communication modes from one frequency band to another frequency band, one or more of processor 120 and interface 124 can cause an input frequency from antenna feed 111 to antenna 200 to switch between the first frequency and the second frequency.

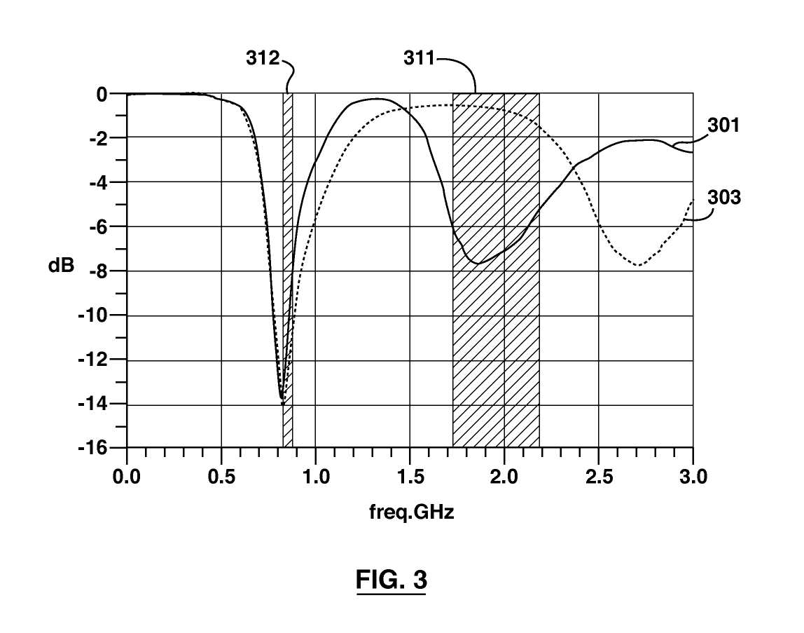

Attention is next directed to FIG. 3 which depicts a return-loss curve of specific non-limiting implementations of antenna 200; in these implementations, first radiating arm 201 is configured resonate between about 1800 MHz to about 1900 MHz, and the combination of first radiating arm 201 electrically connected to second radiating arm 202 is configured to resonate between about 850 MHz to about 900 MHz; further, components of filter network 210 are configured as follows: inductor 201 has an inductance of about 22 nH, first capacitor 209 has a capacitance of about 0.15 pF, and second capacitor 202 has a capacitance of about 1.8 pF. The response of antenna 200 is shown between about 0 MHz and about 3000 MHz (or 3 GHz), with return-loss, in decibels (dB), shown on the y-axis, and frequency shown on the x-axis.

Specifically, FIG. 3 depicts two return-loss curves 301, 303 generated using simulation software: a return-loss curve 301 of antenna 200; and a return-loss curve 303 of a monopole antenna corresponding to a length, and the like, of a combination of first radiating arm 201 and second radiating arm 202 without bandstop filter 203 or bandpass filter 205 there between (e.g., a monopole antenna of the “Low Band” length of FIG. 2).

FIG. 3 also indicates a first frequency range 311 of about 1750 MHz to about 2200 MHz, and a second frequency range 312 of about 800 MHz to about 900 MHz, both GSM bands; it is appreciated that in these implementations, antenna 200 is configured and/or designed so that resonances occur in each of first frequency range 311 and second frequency range 312.

In any event, return-loss curve 303 shows that the above described monopole antenna has a resonance around 800 MHz (within second frequency range 312) and a third harmonic around 2700 MHz, which is out of band for in this design. This third harmonic inherently comes from the dominant-mode frequency at around 800 MHz and is out-of-band in this design; if the dominant-mode resonance is varied (e.g. by changing a length of the monopole antenna), the third-harmonic-mode resonance also varies accordingly.

Return-loss curve 301 shows that antenna 200 has a resonance around 800 MHz (within second frequency range 312), similar to the monopole antenna of return-loss curve 303, which corresponds to a combination of first radiating arm 201 and second radiating arm 202; however, in contrast to return-loss curve 303, return-loss curve 301 of antenna 200 has another resonance around 1800 MHz (within first frequency range 311) corresponding to first radiating arm 201. Furthermore, filter network 210 (i.e. bandstop filter 203 and bandpass filter 205) filter out and/or remove the third harmonic at around 2700 MHz. In other words, filter network 210 is configured to remove redundant resonances and/or harmonic resonances of the combination of first radiating arm 201 and second radiating arm 202.

It is appreciated that the resonance at around 1800 MHz of return-loss curve 301 does not come from a dominant-mode resonance of the combination of first radiating arm 201 and second radiating arm 202, but from first radiating arm 201 and frequency filtering of filter network 210. As such, separate dual-band operation of antenna 200 is enabled.

From another perspective, antenna 200 comprises a single-branch monopole antenna that is physically split by a circuit and/or filter network comprising bandstop filter 203 and bandpass filter 205. In other words, first radiating arm 201 determines the higher frequency resonance in first frequency range 311 and is independent of a length of second radiating arm 202 in high frequency operation. The lower resonance in second frequency range 312 corresponds to a resonance of the entire length of first radiating arm 201 and second radiating arm 202, as filter network 210 acts as an open circuit in high frequency, and as a short circuit in low frequency.

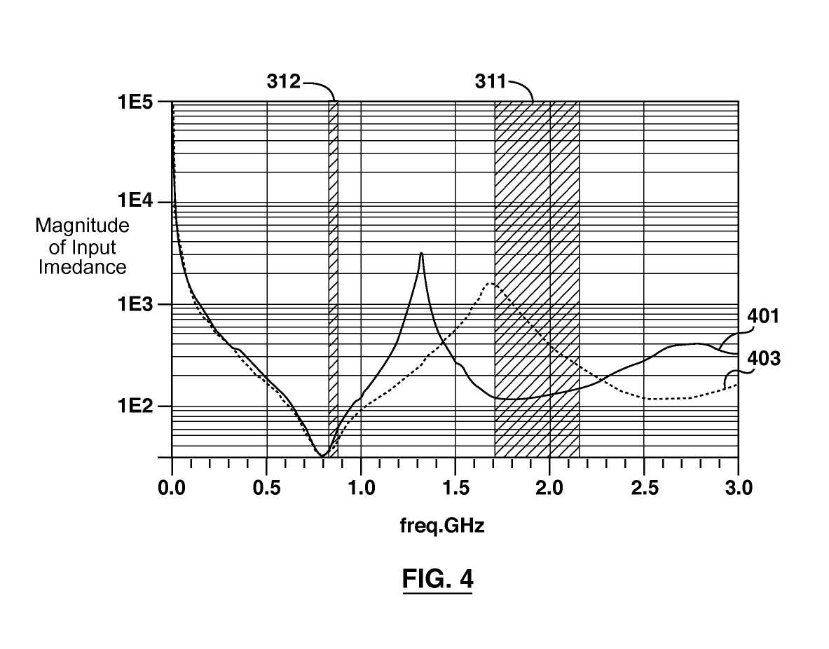

For example, attention is directed to FIG. 4, which depicts an input impedance curve 401 of the same specific non-limiting implementations of antenna 200 described above with respect to FIG. 3, as a function of frequency, and an input impedance curve 403 of the same monopole antenna described above with respect to FIG. 3. Magnitude of input impedance is depicted on the y-axis, and frequency, from about 0 MHz to about 3000 MHz (i.e. about 3 GHz), is depicted on the x-axis. First frequency range 311 and second frequency range 312 are also indicated.

Input impedance curve 401 of antenna 200 shows relatively high impedance around 1800 MHz (and within first frequency range 311) and relatively low impedance around 800 MHz (and within second frequency range 312). In contrast, input impedance curve 403 of the monopole antenna shows a similar impedance to input impedance curve 401 of antenna 200 in second frequency range 312; however, input impedance curve 403 of the monopole antenna has a relatively higher impedance (by at about an order of magnitude than input impedance curve 401), in first frequency range 311. Furthermore, input impedance curve 403 has a relatively impedance than input impedance curve 401 around 2700 MHz, the frequency of the third harmonic depicted in FIG. 3.

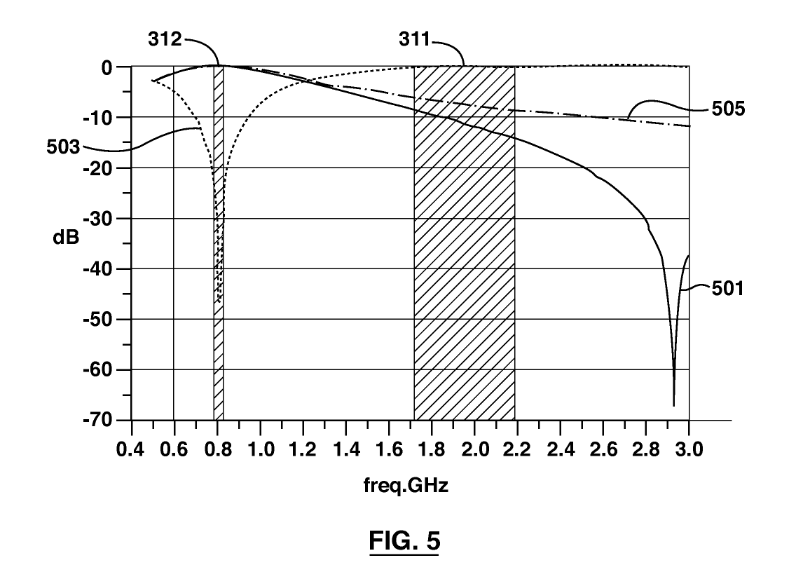

Differences between the same specific non-limiting implementations of antenna 200 and the monopole antenna described above with respect to FIG. 3 are further illustrated in FIG. 5 which depicts transmission coefficients 501 (i.e. S21) and reflection coefficients 503 (i.e. S11) of specific non-limiting implementations of filter network 210 described above with respect to FIG. 3. Decibels are depicted on the y-axis and frequency, from about 400 MHz (i.e. 0.4 GHz) to about 3000 MHz (i.e. about 3 GHz), is depicted on the x-axis. First frequency range 311 and second frequency range 312 are also indicated.

Transmission coefficients 501 show that transmission occurs in second frequency range 312, as filter network 210 acts as a short circuit in this frequency range; transmission coefficients 501 are relatively reduced by orders of magnitude in second frequency range 311 as filter network 210 acts as an open circuit in this frequency range. Similarly, reflection coefficients 503 show very low reflection in second frequency range 312, and high reflection (by orders of magnitude) in first frequency range 311. There is an additional pronounced dip in transmission at about 2900 MHz as bandstop filter 203 filters (i.e. stops) higher frequencies very effectively.

For comparison, transmission coefficients 505 of only bandpass filter 205 are also depicted in FIG. 5 (i.e. bandpass filter 205 without bandstop filter 203). In second frequency range 312, transmission coefficients 505 are similar to transmission coefficients 501. However, in first frequency range 311, transmission coefficients 505 are about 10 dB lower than transmission coefficients 501. In other words, the addition of bandstop filter 203 sharpens the filtering of frequencies between first radiating arm 201 and second radiating arm 202 in first frequency range 311, as compared to bandpass filter 205 alone. Hence, bandstop filter 203 in filter network 210 provides additional frequency filtering in first frequency range 311 that significantly improves band selection in antenna 200 over the use of bandpass filter 205 alone. In some implementations, components of antenna 200 are generally connected in the following order: first radiating arm 201 (connectable to antenna feed 111), bandstop filter 203, bandpass filter 205, second radiating arm 202.

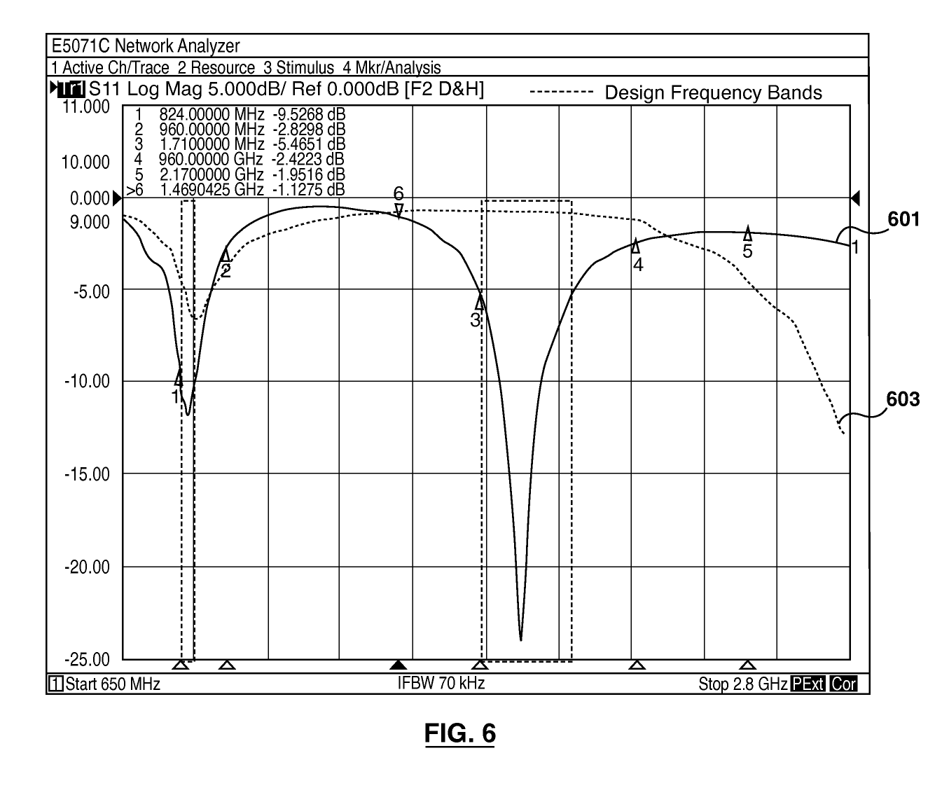

A successful prototype of antenna 200 was built similar to non-limiting implementations of antenna 200 described above with respect to FIG. 3, on a 0.8 mm thick FR4 substrate and using a high-Q inductor to mitigate insertion loss, and a return-loss curve 601 of the successful prototype is shown in FIG. 6, in a frequency range of about 650 MHz to about 3000 MHz, with frequency on the x-axis and return-loss on the y-axis in decibels. Design frequency bands are also depicted in stippled lines, from about 1700 MHz to about 1900 MHz (roughly corresponding to first frequency range 311 described above) and about 800 MHz to about 900 MHz (corresponding to second frequency range 312 described above). It is appreciated that resonances in return-loss curve 601 occur in the design frequency bands. For comparison, a return-loss curve 603 of a prototype of the same monopole antenna described above with respect to FIG. 3 is also shown, which has similar characteristics of simulated return-loss curve 303 of FIG. 3, with a resonance at about 900 MHz and a third harmonic at just below 3000 MHz.

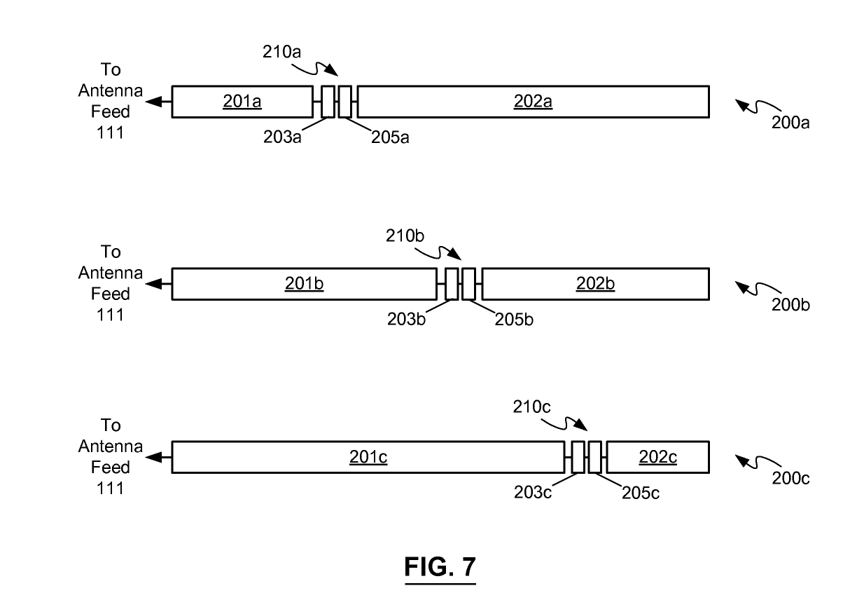

Attention is next directed to FIG. 7, which depicts three antennas 200a, 200b, 200c, each similar to antenna 200, with like elements having like numbers but respectively with an “a”, “b” and “c” appended thereto. Antenna 115 can comprise one or more of antennas 200a, 200b, 200c.

Antenna 200a comprises a first radiating arm 201a (connectable to antenna feed 111), a second radiating arm 202a, and a filter network 210a there between, comprising a bandstop filter 203a and bandpass filter 205a, each of bandstop filter 203a and bandpass filter 205a shown schematically. Similarly, antenna 200b comprises a first radiating arm 201b (connectable to antenna feed 111), a second radiating arm 202b, and a filter network 210b there between, comprising a bandstop filter 203b and bandpass filter 205b, each of bandstop filter 203b and bandpass filter 205b shown schematically. Finally, antenna 200c comprises a first radiating arm 201c (connectable to antenna feed 111), a second radiating arm 202c, and a filter network 210c there between, comprising a bandstop filter 203c and bandpass filter 205c, each of bandstop filter 203c and bandpass filter 205c shown schematically.

Furthermore a length of each antenna 200a, 200b, 200c is about the same, but a relative location of each combination of bandstop filter 203a, 203b, 203c and bandpass filter 205a, 205b, 205c within each antenna 200a, 200b, 200c is different. For example first radiating arm 201a is shorter than first radiating arm 201b, and first radiating arm 201b is shorter than first radiating arm 201c. Hence, a length of second radiating arm 202a is longer than a length of second radiating arm 202b, and a length of second radiating arm 202b is longer than a length of second radiating arm 202c.

In other words, while the total length of each antenna 200a, 200b, 200c is about the same, the lengths of each of the respective radiating arms are different.

Hence, when the total length of each antenna 200a, 200b, 200c is about the same as antenna 200, the lower band resonance of each antenna 200a, 200b, 200c will be about the same as the lower band resonance of antenna 200. For example, when the lower band resonance of antenna 200 is in a range of 800 MHz to 900 MHz, then the lower band resonance of antennas 200a, 200b, 200c are also in a range of 800 MHz to 900 MHz.

However, as the length of first radiating arms 201a, 201b, 201c varies, a higher band resonance of each antenna 200a, 200b, 200c will vary depending on a length of first radiating arms 201a, 201b, 201c. It is appreciated that values of components of filter networks 210a, 210b, 210c are adjusted accordingly to act as short circuits at the lower band resonance frequency and as open circuits at the higher band resonance frequency.

In other words, each filter network 210a, 210b, 210c is generally configured to electrically isolate respective first radiating arms 201a, 201b, 201c and respective second radiating arms 202a, 202b, 202c at a respective frequency corresponding to a resonance length defined by a length of respective first radiating arms 201a, 201b, 201c and to electrically connect respective first radiating arms 201a, 201b, 201c and second radiating arms 202a, 202b, 202c at a frequency corresponding to a resonance length defined by a total length of respective first radiating arms 201a, 201b, 201c and second radiating arms 202a, 202b, 202c.

Hence, unlike a conventional monopole, a higher resonance frequency of antennas 200, 200a, 200b 200c is controllable regardless of the total length of the monopole. This advantageous for antenna designers in that a single-branched antenna, split by a bandstop/bandpass filter network, can support dual or multiband operations.

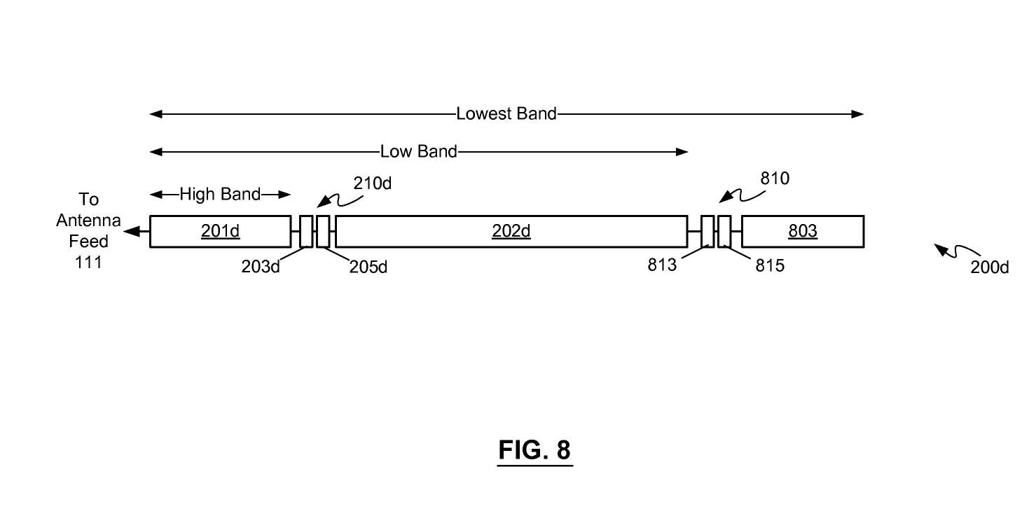

Attention is next directed to FIG. 8 which depicts an antenna 200d, similar to antenna 200, with like elements having like numbers, however with a “d” appended thereto. Antenna 115 can comprise antenna 200d. Antenna 200d comprises a first radiating arm 201d (connectable to antenna feed 111), a second radiating arm 202d, and a filter network 210d there between, comprising a bandstop filter 203d and bandpass filter 205d, each of bandstop filter 203d and bandpass filter 205d shown schematically. It is appreciated that first radiating arm 201d resonates at a first frequency and that the combination of second radiating arm 202d and first radiating arm 201d resonate at a second frequency lower than the first frequency, as described above. Further, filter network 210d is configured to: electrically isolate first radiating arm 201d from second radiating arm 202d at the first frequency, and electrically connect first radiating arm 201d and second radiating arm 202d at the second frequency.

However, antenna 200d further comprises: a third radiating arm 803, third radiating arm 803, second radiating arm 202d and first radiating arm 201d, when electrically connected, configured to resonate at a third frequency lower than the second frequency; and, a second filter network 810 comprising a second bandstop filter 813 and a second bandpass filter 815, second filter network 810 filtering a respective electrical connection between second radiating arm 202d and third radiating arm 803, second filter network 810 configured to: electrically isolate second radiating arm 202d from third radiating arm 803 at the second frequency, and electrically connect second radiating arm 202d and third radiating arm 803 at the third frequency.

Furthermore, each filter network 210d is further configured to electrically connect first radiating arm 201d to second radiating arm 202d at the third frequency. Hence, the circuits and/or components of filter network 210d, and/or bandstop filter 203d and bandpass filter 205d, can be different than circuits and/or components of filter network 210, and/or bandstop filter 203 and bandpass filter 205, in order to provide the additional functionality at the third frequency.

In any event, antenna 200d resonates at three different frequencies: a first frequency corresponding to a length of first radiating arm 201d (the length labelled as “High Band” in FIG. 2), a second frequency corresponding to a total length of first radiating arm 201d combined with second radiating arm 202d (the total length labelled as “Low Band” in FIG. 2), and a third frequency corresponding to a total length of first radiating arm 201d combined with second radiating arm 202d and third radiating arm 803 (the total length labelled as “Lowest Band” in FIG. 2). As the “High Band” length is shorter than the “Low Band” length, the first frequency will be higher than the second frequency, as with antenna 200; similarly, as the “Low Band” length is shorter than the “Lowest Band” length, the second frequency will be higher than the third frequency.

In other words, as the frequency increases, the effective length of antenna 200d decreases in steps from the “Lowest Band” length to the “Low Band” length to the “High Band” length, as each bandstop/bandpass filter network (i.e. bandstop filter 203d combined with bandpass filter 205d, and second bandstop filter 813 combined with second bandpass filter 815) filters successively higher frequencies. In this manner, antenna 200d is configured to resonate at three different frequencies.

Hence, for example antenna 200d could be configured to resonate in frequency bands corresponding to 700 to 960 MHz, 1710-2170 MHz, and 2500-2700 MHz.

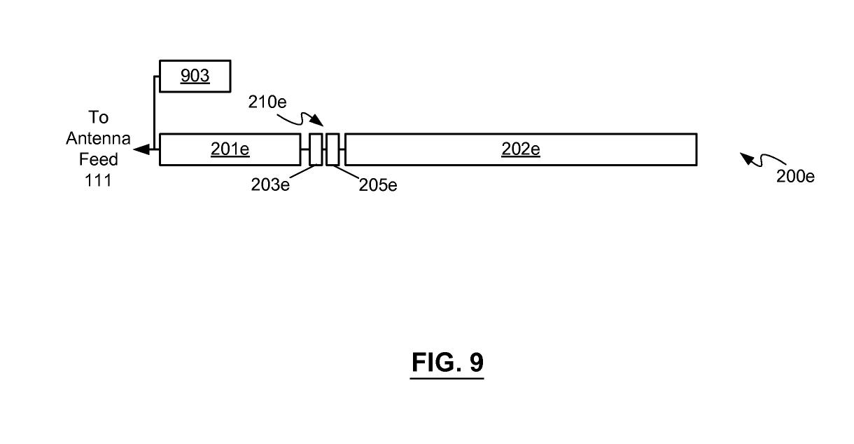

Attention is next directed to FIG. 9 which depicts an antenna 200e, similar to antenna 200, with like elements having like numbers, however with an “e” appended thereto. Antenna 115 can comprise antenna 200e. Antenna 200e comprises a first radiating arm 201e (connectable to antenna feed 111), a second radiating arm 202e, and a filter network 210e there between comprising a bandstop filter 203e and bandpass filter 205e, each of bandstop filter 203e and bandpass filter 205e shown schematically. It is appreciated that first radiating arm 201e resonates at a first frequency and that the combination of second radiating arm 202e and first radiating arm 201e resonate at a second frequency lower than the first frequency, as described above. Further filter network 210e electrically isolates first radiating arm 201e from second radiating arm 202e at the first frequency, and electrically connects first radiating arm 201e from second radiating arm 202e at the second frequency.

However, antenna 200d further comprises at least a third radiating arm 903 connectable to antenna feed 111, third radiating arm 903 configured to resonate at a third frequency different from the first frequency and the second frequency.

Third radiating arm 903, as depicted, can be shorter than first radiating arm 201e so that third radiating arm 903 resonates at a higher frequency than first radiating arm 201e. Alternatively, third radiating arm 903 can be longer than first radiating arm 201e, but shorter than the combination of first radiating arm 201e and second radiating arm 202e, so that third radiating arm 903 resonates at a frequency between the first frequency and the second frequency. In yet a further alternative, third radiating arm 903 can be longer the combination of first radiating arm 201e and second radiating arm 202e, so that third radiating arm 903 resonates at a frequency lower than the second frequency. However, a length of third radiating arm 903 can also be similar to a length of first radiating arm 201e or a length of a combination of first radiating arm 201e and second radiating arm 202e to provide more coverage of the respective frequency bands.

For example, when first radiating arm 201e and second radiating arm 202e are configured to resonate in frequency ranges of about 700 to about 960 MHz, and about 1710 to about 2170 MHz, third radiating arm 903 can be configured to resonate in a frequency range of about 2500 to about 2700 MHz, so that antenna 200e has tri-band coverage of commercial frequency ranges (e.g. for LTE bands, GSM bands, UMTS bands, and/or WLAN bands).

In yet further implementations, antenna 200e can comprise more than one additional radiating arm connectable to antenna feed 111, similar to third radiating arm 903, of a similar or different length to third radiating arm 903. When the more than one additional radiating arm is of a different length than third radiating arm 903, antenna 200e has at least four-band coverage.

Furthermore, while third radiating arm 903 is depicted as parallel to first radiating arm 201e, in other implementations, third radiating arm 903 can be perpendicular to first radiating arm 201e, or at any other angle. Indeed the orientation of each of third radiating arm 903 is generally appreciated to be non-limiting.

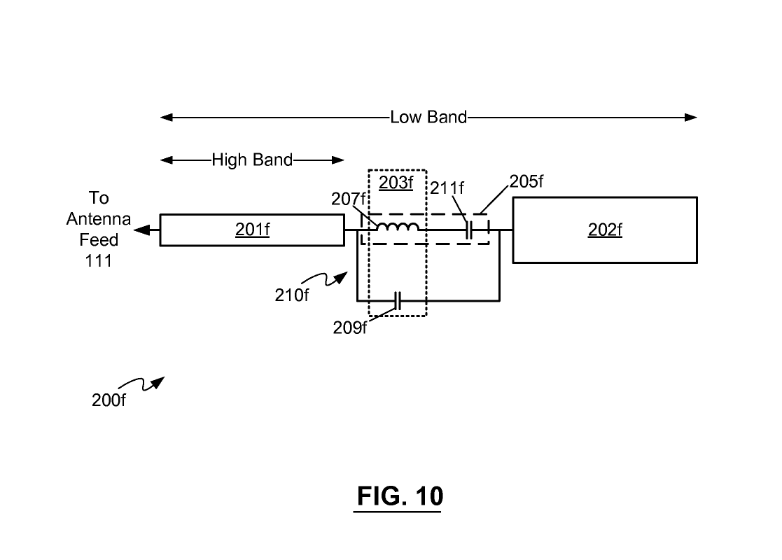

Persons skilled in the art will appreciate that there are yet more alternative implementations and modifications possible. For example, attention is next directed to FIG. 10 which depicts an antenna 200f, substantially similar to antenna 200, with like elements having like numbers, but with an “f” appended thereto. Antenna 115 can comprise antenna 200f. Antenna 200f comprises: a first radiating arm 201f connectable to antenna feed 111, first radiating arm 201f configured to resonate at a first frequency; a second radiating arm 202f, second radiating arm 202f and first radiating arm 201f, when electrically connected, configured to resonate at a second frequency lower than the first frequency; a filter network 210f comprising a bandstop filter 203f and a bandpass filter 205f, filter network 210f filtering an electrical connection between first radiating arm 201f and second radiating arm 202f, filter network 210f configured to: electrically isolate first radiating arm 201f from second radiating arm 202f at the first frequency, and electrically connect first radiating arm 201f and second radiating arm 202f at the second frequency. Further, in specific non-limiting implementations, as depicted, bandstop filter 203f comprises an inductor 207f and a first capacitor 209f connected in parallel (and/or in shunt) between first radiating arm 201f and second radiating arm 202f. Further, in the depicted specific non-limiting implementations, bandpass filter 205f comprises inductor 207f and a second capacitor 211f connected in series with inductor 207f, second capacitor 211f located between inductor 207f and second radiating arm 202f. Second capacitor 211f is also connected in parallel with first capacitor 209f.

However, each of first radiating arm 201f and second radiating arm 202f are different widths, with second radiating arm 202f being wider than first radiating arm 201f. By varying the width of one or more of first radiating arm 201f and second radiating arm 202f, resonances of antenna 200f can be changed; furthermore, antenna efficiency and bandwidth can be increased.

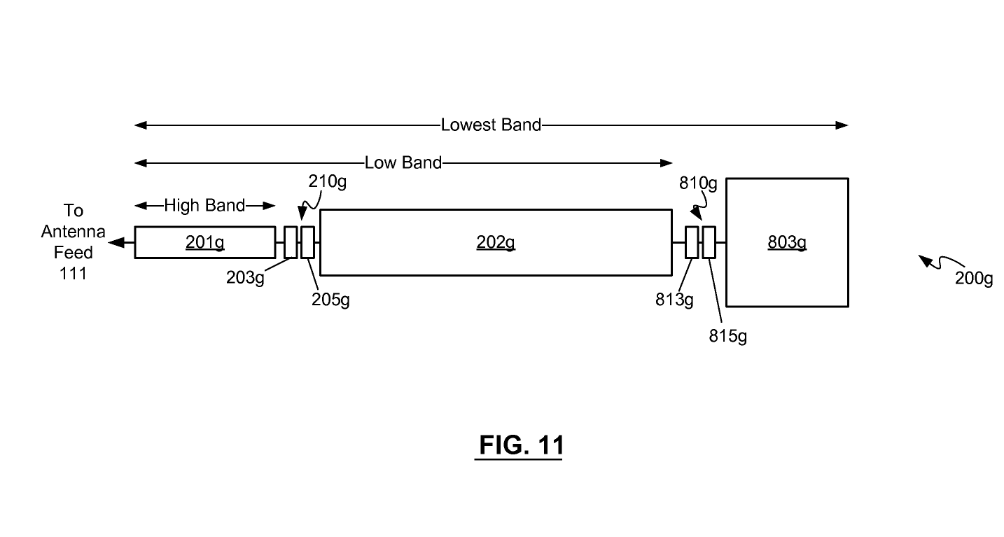

It is yet further appreciated that for antenna 200d, comprising first radiating arm 201d, second radiating arm 202d and third radiating arm 803, widths of each of first radiating arm 201d, second radiating arm 202d and third radiating arm 803 can be different from one another. For example, attention is next directed to FIG. 11 which depicts an antenna 200g, substantially similar to antenna 200d, with like elements having like numbers, but with a “g” appended thereto. Antenna 115 can comprise antenna 200g. Antenna 200g comprises a first radiating arm 201g (connectable to antenna feed 111), a second radiating arm 202g, and a filter network 210g there between, comprising a bandstop filter 203g and bandpass filter 205g, each of bandstop filter 203g and bandpass filter 205g shown schematically. Antenna 200g further comprises: a third radiating arm 803g, and, a second filter network 810g comprising a second bandstop filter 813g and a second bandpass filter 815g, similar to antenna 200d. However, each of first radiating arm 201g, second radiating arm 202g and third radiating arm 803g are different widths, with second radiating arm 202g being wider than first radiating arm 201g, and third radiating arm 803g being wider than second radiating arm 202g. By varying the width of one or more of first radiating arm 201g, second radiating arm 202g and third radiating arm 803g, resonances of antenna 200g can be changed; furthermore, antenna efficiency and bandwidth can be increased.

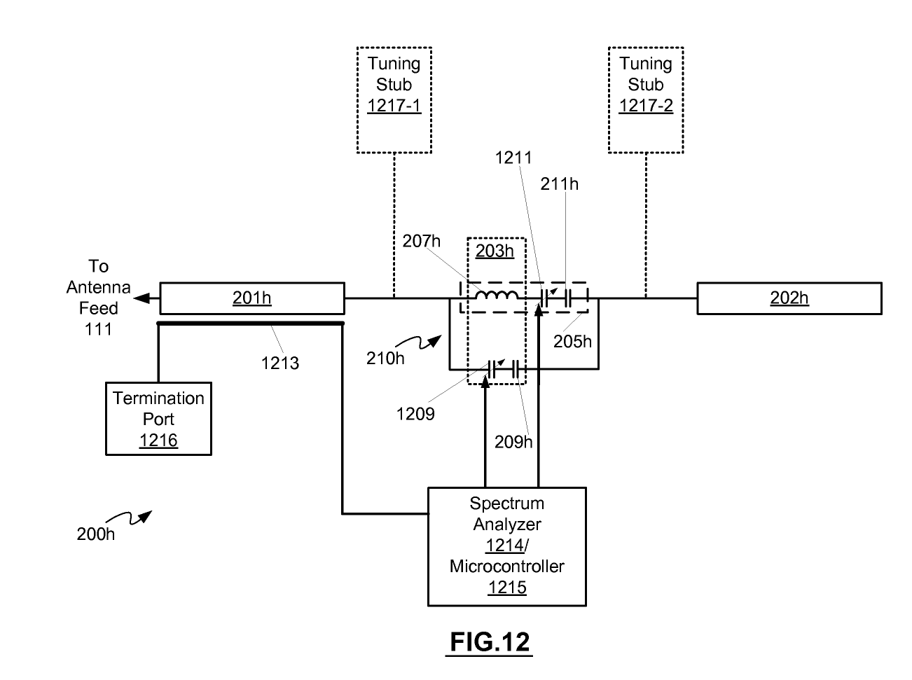

Attention is next directed to FIG. 12 which depicts an antenna 200h, substantially similar to antenna 200, with like elements having like numbers, but with an “h” appended thereto. Antenna 115 can comprise antenna 200h. Antenna 200h comprises: a first radiating arm 201h connectable to antenna feed 111, first radiating arm 201h configured to resonate at a first frequency; a second radiating arm 202h, second radiating arm 202h and first radiating arm 201h, when electrically connected, configured to resonate at a second frequency lower than the first frequency; a filter network 210h comprising a bandstop filter 203h and a bandpass filter 205h, filter network 210h filtering an electrical connection between first radiating arm 201h and second radiating arm 202h, filter network 210h configured to: electrically isolate first radiating arm 201h from second radiating arm 202h at the first frequency, and electrically connect first radiating arm 201h and second radiating arm 202h at the second frequency.

Further, bandstop filter 203h comprises an inductor 207h, and a capacitor 209h, and bandpass filter 205h comprises inductor 207h and a capacitor 211h. However, in these implementations, one or more of each of bandstop filter 203h and bandpass filter 205h are tunable. For example, as depicted, antenna 200h further comprises at least one tunable capacitor 1209, 1211 for one or more of each of bandstop filter 203h and bandpass filter 205h. Specifically, as depicted, bandstop filter 203h comprises tunable capacitor 1209 in series with capacitor 209h, and in parallel with inductor 207h; and bandpass filter 205h comprises tunable capacitor 1211 in series with capacitor 211h and inductor 207h.

In order to tune each of tunable capacitor 1209, 1211, antenna 200h further comprises: a directional coupler 1213 capacitively coupled to first radiating arm 201h; a spectrum analyzer 1214 and a microcontroller 1215 in communication with directional coupler 1213 and at least one tunable capacitor 1209, 1211, spectrum analyzer 1214 configured to determine an input frequency of first radiating arm 201h and microcontroller 1215 configured to tune at least one tunable capacitor 1209, 1211 according to the input frequency. Directional coupler 1213 can terminate at an impedance termination port 1216, which provides both a reference impedance, and minimizes reflection from termination port 1216.

In other words, directional coupler 1213 couples to first radiating arm 201h and measures and/or samples an input frequency thereof; spectrum analyzer 1214 receives a signal from directional coupler 1213, and determines the input frequency of first radiating arm 201h from the signal, i.e. the input frequency received from antenna feed 111. For example, the input frequency can comprise the first frequency or the second frequency. The input frequency is determined, and spectrum analyzer 1214 communicates the input frequency to microcontroller 1215, which can responsively control at least one tunable capacitor 1209, 1211 accordingly, via respective outputs to each of tunable capacitors 1209, 1211.

The capacitance values to which each of tunable capacitors 1209, 1211 can be tuned can based on a lookup table, and the like, stored at microcontroller 1215. For example, each of tunable capacitors 1209, 1211 can be tuned to respective first values when the input frequency is about the first frequency, and each of tunable capacitors 1209, 1211 can be tuned to respective second values when the input frequency is about the second frequency. The respective first values and respective second values can be stored in a lookup table, and the like, in respective association with each of the first frequency and the second frequency. Further, if either of the first frequency or the second frequency drifts due to, for example, changes in input impedance at antenna 200h, at least one tunable capacitors 1209, 1211 can be tuned in a feedback loop with directional coupler 1213, spectrum analyzer 1214 and microcontroller 1215 to maintain the first frequency or the second frequency.

In FIG. 12, it is assumed that spectrum analyzer 1214 and microcontroller 1215 are combined into one device, however, in other implementations, spectrum analyzer 1214 and microcontroller 1215 can be separate devices in communication with each other, microcontroller 1215 receiving the measured input frequency from spectrum analyzer 1214.

As depicted, antenna 200h can optionally comprise one or more tuning stubs 1217-1, 1217-2 located before and/or after filter network 210h to provide additional tuning capability. Each tuning stub 1217-1, 1217-2 can receptively contribute at least some impedance matching for each of first radiating arm 201h and second radiating arm 202h. Each tuning stub 1217-1, 1217-2 can be a same or different size as each of first radiating arm 201h and second radiating arm 202h.

Further while only two tunable capacitors 1209, 1211 are depicted in FIG. 12, in other implementations, filter network 210h can comprise more than two tunable capacitor and/or at least one tunable inductor.

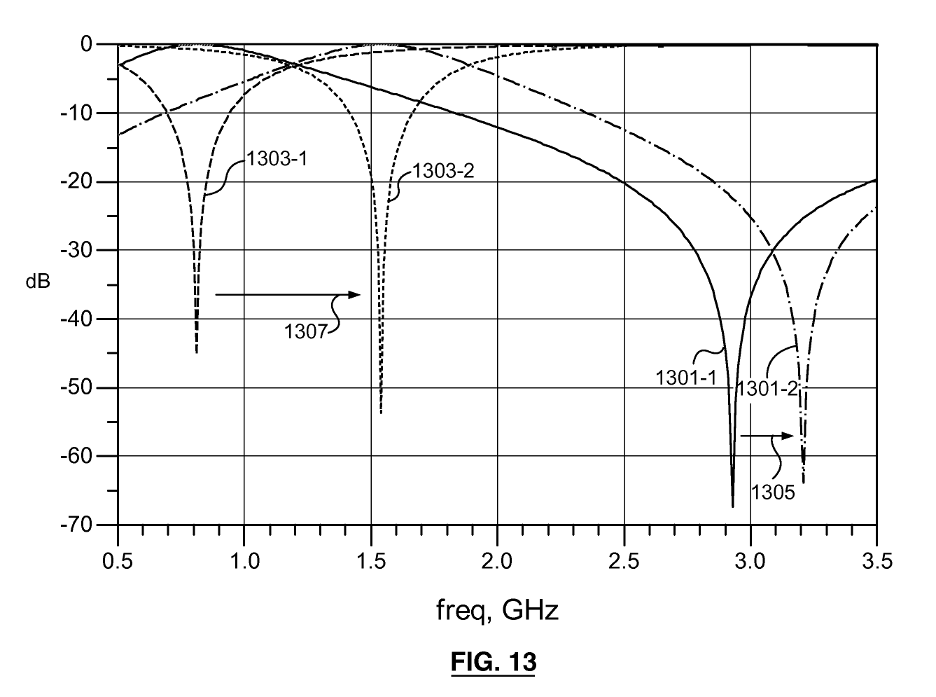

Attention is next directed to FIG. 13 which depicts transmission coefficients 1301-1, 1301-2 (i.e. S21) and reflection coefficients 1303-1, 1303-2 (i.e. S11) of specific non-limiting implementations of filter network 210h as a capacitance value of tunable capacitor 1211 is decreased. It is assumed in FIG. 13 that a value of tunable capacitor 1209 is fixed. Decibels are depicted on the y-axis and frequency, from about 500 MHz (i.e. 0.5 GHz) to about 3500 MHz (i.e. about 3.5 GHz), is depicted on the x-axis.

Specifically transmission coefficients 1301-1 and reflection coefficients 1303-1 represent a response of filter network 210h when tunable capacitor 1211 is at a first capacitance value, and transmission coefficients 1301-2 and reflection coefficients 1303-2 represent a response of filter network 210h when tunable capacitor 1211 is at a second capacitance value lower than the first capacitance value.

It is apparent from FIG. 13 that resonance frequencies of both transmission and reflection of filter network 210h generally increase to higher frequencies as a capacitance of tunable capacitor 1211 is decreased, the increase in resonance frequencies represented by arrows 1305, 1307. It is further appreciated that a resonance in transmission is indicative of frequencies at which filter network 210h electrically connects first radiating arm 201h with second radiating arm 202h. Similarly, a resonance in reflection is indicative of frequencies at which filter network 210h electrically isolates first radiating arm 201h from second radiating arm 202h.

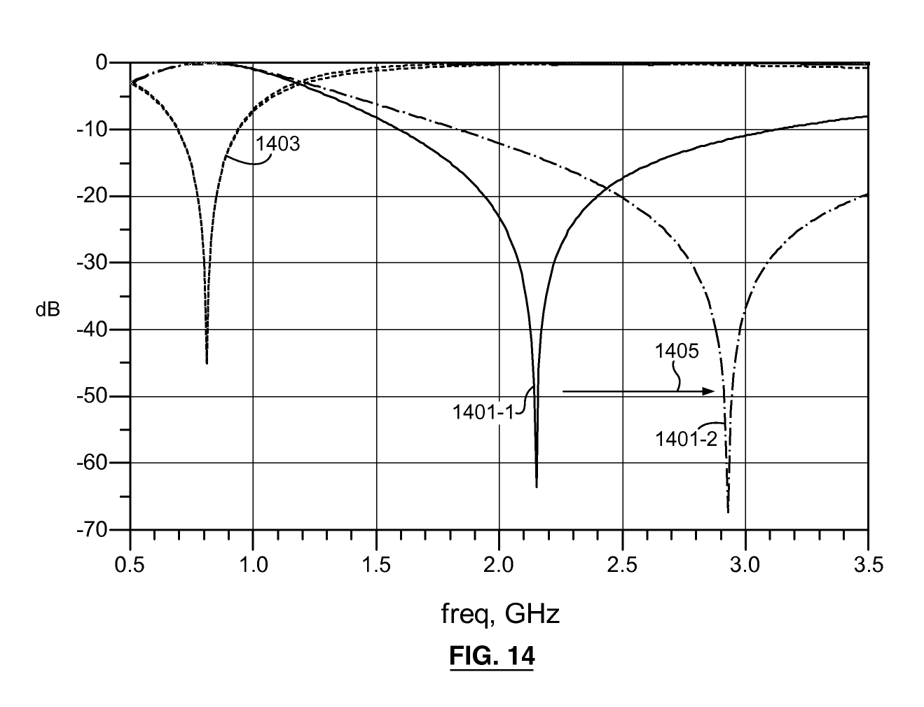

Attention is next directed to FIG. 14 which depicts transmission coefficients 1401-1, 1401-2 (i.e. S21) and reflection coefficients 1403 of specific non-limiting implementations of filter network 210h as a capacitance value of tunable capacitor 1209 is decreased. It is assumed in FIG. 14 that a value of tunable capacitor 1211 is fixed. Decibels are depicted on the y-axis and frequency, from about 500 MHz (i.e. 0.5 GHz) to about 3500 MHz (i.e. about 3.5 GHz), is depicted on the x-axis.

Specifically transmission coefficients 1401-1 represent a response of filter network 210h when tunable capacitor 1211 is at a first capacitance value, and transmission coefficients 1401-2 represent a response of filter network 210h when tunable capacitor 1211 is at a second capacitance value lower than the first capacitance value. Reflection coefficients 1403 represent a response of filter network 210h at each capacitance value: in other words, reflection is substantially similar at each capacitance value.

It is apparent from FIG. 14 that resonance frequencies of transmission of filter network 210h generally increases to higher frequencies as a capacitance of tunable capacitor 1209 is decreased, the increase in resonance frequency represented by arrow 1405. However, a resonance frequency of reflection of filter network 210h is generally unchanged; indeed, reflection coefficients 1403 represent It is further appreciated that a resonance in transmission is indicative of frequencies at which filter network 210h electrically connects first radiating arm 201h with second radiating arm 202h. Similarly, a resonance in reflection is indicative of frequencies at which filter network 210h electrically isolates first radiating arm 201h from second radiating arm 202h.

Hence, from FIGS. 13 and 14, it is apparent that when a desired frequency of resonance begins to increase, a capacitance of one or more of tunable capacitors 1209, 1211 can be decreased, and similarly when a desired frequency of resonance begins to decrease, a capacitance of one or more of tunable capacitors 1209, 1211 can be increased. Changes in the frequencies can be determined using directional coupler 1213 and spectrum analyzer 1214.

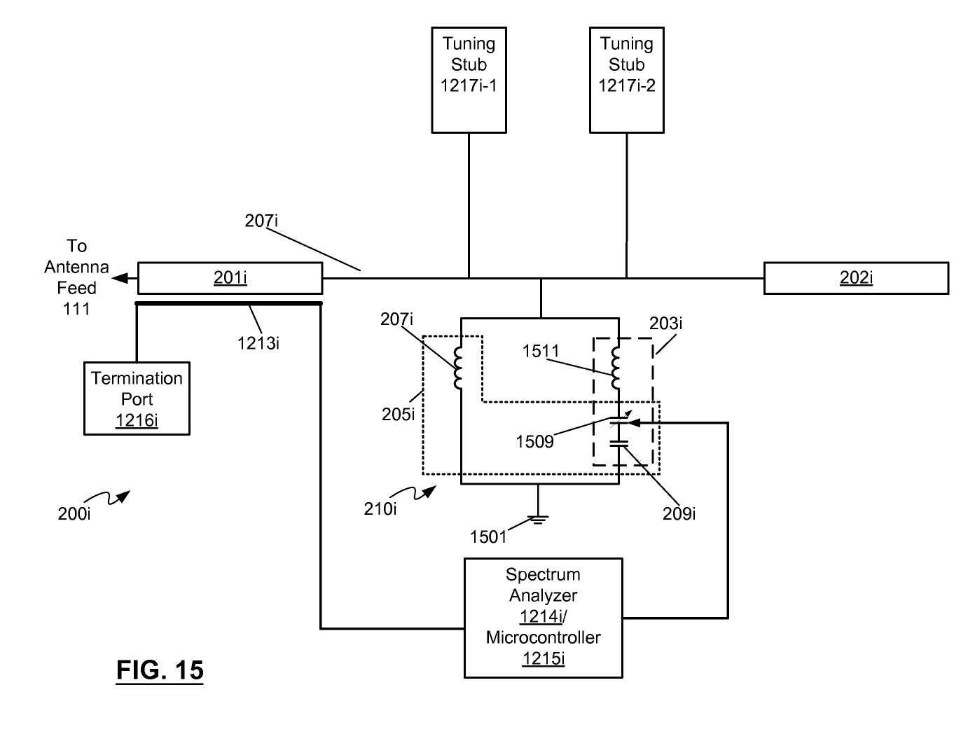

Attention is next directed to FIG. 15 which depicts an antenna 200i, substantially similar to antenna 200, with like elements having like numbers, but with an “i” appended thereto. Antenna 115 can comprise antenna 200i. Antenna 200i comprises: a first radiating arm 201i connectable to antenna feed 111, first radiating arm 201i configured to resonate at a first frequency; a second radiating arm 202i, second radiating arm 202i and first radiating arm 201i, when electrically connected, configured to resonate at a second frequency lower than the first frequency; a filter network 210i comprising a bandpass filter 205i and a bandstop filter 203i, filter network 210i filtering an electrical connection between first radiating arm 201i and second radiating arm 202i, filter network 210i configured to: electrically isolate first radiating arm 201i from second radiating arm 202i at the first frequency, and electrically connect first radiating arm 201i and second radiating arm 202i at the second frequency. Filter network 210i is connected in shunt from each of first radiating arm 201i and second radiating arm 202i to a ground 1501, for example a ground plane of device 101.

Further, bandpass filter 205i comprises an inductor 207i, and a capacitor 209i, and bandstop filter 203i comprises inductor 1511 and capacitor 209i. Similar to antenna 200h, in these implementations, each of bandpass filter 205i and bandstop filter 203i are tunable. For example, as depicted, antenna 200i further comprises at least one tunable capacitor 1509 common to both bandpass filter 205i and bandstop filter 203i. Specifically, as depicted, bandpass filter 205i comprises inductor 207i in parallel with at least one tunable capacitor 1509, which is in series with capacitor 209i, to ground 1501; and bandstop filter 203i comprises inductor 1511 in series with at least one tunable capacitor 1509 and capacitor 209i to ground 1501.

In order to tune at least one tunable capacitor 1509, antenna 200i further comprises: a directional coupler 1213i capacitively coupled to first radiating arm 201i; a spectrum analyzer 1214i and a microcontroller 1215i in communication with directional coupler 1213i and at least one tunable capacitor 1509, spectrum analyzer 1214i configured to determine an input frequency of first radiating arm 201i, and microcontroller 1215i configured to tune at least one tunable capacitor 1509 according to the input frequency. Directional coupler 1213i can terminate at an impedance termination port 1216i, which provides both a reference impedance, and minimizes reflection from termination port 1216i.

In other words, directional coupler 1213i couples to first radiating arm 201i and measures and/or samples an input frequency thereof; spectrum analyzer 1214i receives a signal from directional coupler 1213i, and determines the input frequency of first radiating arm 201i from the signal, i.e. the input frequency received from antenna feed 111. For example, the input frequency can comprise the first frequency or the second frequency. The input frequency is determined, and spectrum analyzer 1214i communicates the input frequency to microcontroller 1215i, which can responsively control at least one tunable capacitor 1509 accordingly, via an output to at least one tunable capacitor 1509.

The capacitance values to which at least one tunable capacitor 1509 can be tuned can based on a lookup table, and the like, stored at microcontroller 1215i. For example, at least one tunable capacitor 1509 can be tuned to a first value when the input frequency is about the first frequency, and at least one tunable capacitor 1509 can be tuned to a second value when the input frequency is about the second frequency. The first value and second value can be stored in a lookup table, and the like, in respective association with each of the first frequency and the second frequency. Further, if either of the first frequency or the second frequency drifts due to, for example, changes in input impedance at antenna 200i, at least one tunable capacitor 1509 can be tuned in a feedback loop with directional coupler 1213i, spectrum analyzer 1214i and microcontroller 1215i to maintain the first frequency or the second frequency

In FIG. 15, it is assumed that spectrum analyzer 1214i and microcontroller 1215i are combined into one device, however, in other implementations, spectrum analyzer 1214i and microcontroller 1215i can be separate devices in communication with each other, microcontroller 1215i receiving the measured input frequency from spectrum analyzer 1214i.

As depicted, antenna 200i can optionally comprise one or more tuning stubs 1217i-1, 1217i-2 located before and/or after filter network 210i to provide additional tuning capability. Each tuning stub 1217i-1, 1217i-2 can receptively contribute at least some impedance matching for each of first radiating arm 201i and second radiating arm 202i. Each tuning stub 1217i-1, 1217i-2 can be a same or different size as each of first radiating arm 201i and second radiating arm 202i.

Further while only one tunable capacitor 1509 is depicted in FIG. 15, in other implementations, filter network 210i can comprise more than one tunable capacitor and/or at least one tunable inductor.

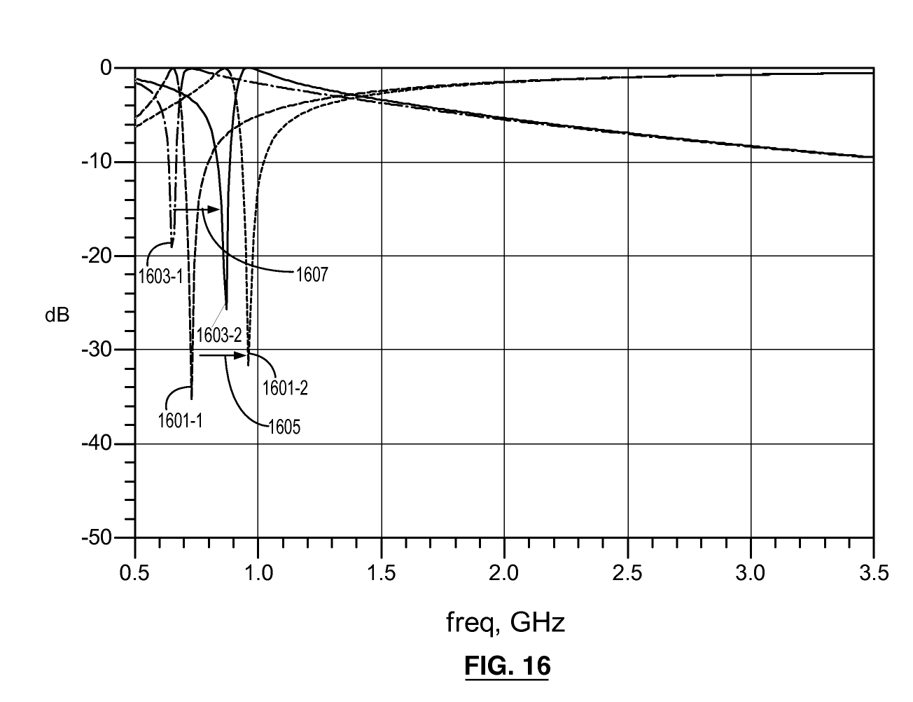

Attention is next directed to FIG. 16 which depicts transmission coefficients 1601-1, 1601-2 (i.e. S21) and reflection coefficients 1603-1, 1603-2 (i.e. S11) of specific non-limiting implementations of filter network 210i as a capacitance value of tunable capacitor 1509 is decreased. Decibels are depicted on the y-axis and frequency, from about 500 MHz (i.e. 0.5 GHz) to about 3500 MHz (i.e. about 3.5 GHz), is depicted on the x-axis.

Specifically transmission coefficients 1601-1 and reflection coefficients 1603-1 represent a response of filter network 210i when tunable capacitor 1509 is at a first capacitance value, and transmission coefficients 1601-2 and reflection coefficients 1603-2 represent a response of filter network 210i when tunable capacitor 1509 is at a second capacitance value lower than the first capacitance value.

It is apparent from FIG. 16 that resonance frequencies of both transmission and reflection of filter network 210i generally increase to higher frequencies as a capacitance of tunable capacitor 1509 is decreased, the increase in resonance frequencies represented by arrows 1605, 1607. It is further appreciated that a resonance in transmission is indicative of frequencies at which filter network 210i electrically connects first radiating arm 201i with second radiating arm 202i. Similarly, a resonance in reflection is indicative of frequencies at which filter network 210i electrically isolates first radiating arm 201i from second radiating arm 202i.

Hence, from FIG. 16, it is apparent that when a desired frequency of resonance begins to increase, a capacitance of tunable capacitor 1509 can be decreased, and similarly when a desired frequency of resonance begins to decrease, a capacitance of tunable capacitors 1509 can be increased. Changes in the frequencies can be determined using directional coupler 1213i and spectrum analyzer 1214i.

Hence, from at least FIGS. 12 and 15 it is apparent that a variety of filter networks, comprising bandstop filters and bandpass filters, are within the scope of present implementations.

In any event, antennas with a combined bandpass/bandstop filter network are described herein that can replace a plurality of antennas at a mobile electronic device. The specific resonance bands of the antennas described herein can be varied by varying the dimensions of components of the antennas to advantageously align the bands with bands used by service providers, and by providing a bandpass/bandstop filter network between radiating arms to control a resonant length of the antennas. In some implementations, capacitance and/or inductance of one or more of bandstop filters and bandpass filters can be tuned. Further, the present antennas obviate the need to use different antennas for different bands in different regions.

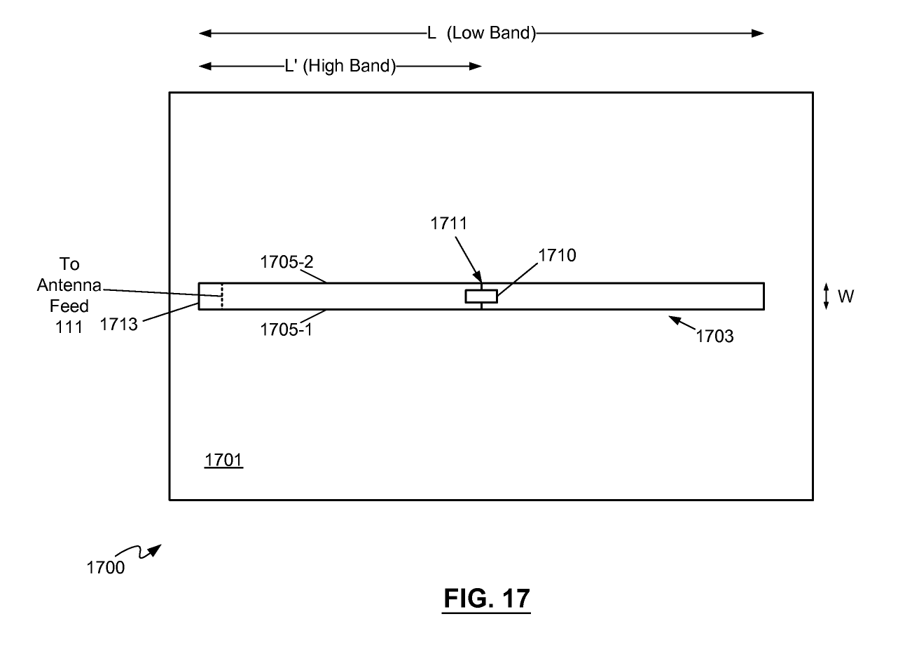

Similar concepts can also be applied to slot antennas. For example, attention is next directed to FIG. 17, which depicts an antenna 1700, according to non-limiting implementations. Antenna 115 can comprise antenna 1700. Antenna 1700 comprises: a ground plane 1701; a slot antenna 1703 in ground plane 1701, slot antenna 1700 connectable to antenna feed 111, and configured to resonate at a first frequency when surface current from antenna feed 111 flows around slot antenna 1703, slot antenna 1703 comprising a first side 1705-1 and a second side 1705-2 separated by a width, W. In general slot antenna 1703 is a slot and/or a hole cut in ground plane 1701, and/or cut out of a ground plane 1701; for example, in some implementations, chassis 109 comprises ground plane 1701, and slot antenna 1703 is a slot in chassis 109. Resonance occurs when ground plane 1701 is driven as an antenna by a driving frequency supplied by antenna feed 111: slot antenna 1703 radiates electromagnetic waves similar to a dipole antenna. A shape and size of slot antenna 1703, as well as the driving frequency, determine the radiating current distribution. For example, a length L, of slot antenna 1703 can define a resonance length of slot antenna 1703, length L being longer than width W (i.e. slot antenna 1703 is longer than it is wide, and hence first side 1705-1 comprises a first long side, and second side 1705-2 comprises a second long side). It is further appreciated that a connection to antenna feed 111 can include a coaxial cable, which includes a connection to a core of the coaxial cable at one of sides 1705-1, 1705-2, and a connection to a ground of the coaxial cable on an opposite side 1705-1, 1705-2. Indeed, while not depicted, slot antenna 1703 is generally connectable to antenna feed 111 using any suitable connector, including, but not limited to, wires, solder, plugs, electronic traces, and the like. Indeed, in some implementations slot antenna 1703 is hardwired and/or coupled to antenna feed 111; further, slot antenna 1703 can comprise a connector to antenna feed 111.

Antenna 1700 further comprises a filter network 1710 bridging first side 1710-1 and second side 1710-2 at a given position 1711, across width W, from a surface-current-originating end 1713 of slot antenna 1703. Filter network 1710 is generally configured to: electrically isolate first side 1705-1 from second side 1705-2 at the first frequency so that length, L, of slot antenna 1703 defines a resonant length of slot antenna 1703 at the first frequency; and, electrically connect first side 1705-1 and second side 1705-2 at a second frequency higher than the first frequency, so that the surface current flows across filter network 1710 at given position L′, thereby shortening the resonance length of slot antenna 1703 and slot antenna 1703 resonates at the second frequency. Furthermore, while filter network 1710 bridges first side 1705-1 and second 1705-2, each connection between filter network 1710 and first side 1705-1, and second side 1705-2, need not be exactly at given position 1711; rather the bridging can occur at an angle to one or more of first side 1705-1 and second 1705-2. It is further appreciated that bridging comprises an electrical bridge between first side 1705-1 and second 1705-2 such that filter network 1710 is electrically connected to both first side 1705-1 and second side 1705-2, and further, filter network 1710 can provide an electrical connection between first side 1705-1 and second 1705-2, depending on the input frequency of antenna feed 111. In any event, filter network 1710 is generally configured to electrically connect first side 1705-1 and second side 1705-2 at a same frequency corresponding to a resonance length defined by the distance between given position 1711 and surface-current-originating end 1713.

For example, length L (also labelled “Low Band” in FIG. 17) of slot antenna 1703 corresponds to a resonance at the first frequency, and a distance L′ (also labelled “High Band”) between given position 1711 and surface-current-originating end 1713 of slot antenna 1703 corresponds to resonance at the second frequency. In other words, length L corresponds to an effective length and/or a resonance length that will produce a resonance at the first frequency, and distance L′ corresponds to an effective length and/or a resonance length that will produce a resonance at the second frequency. Hence, filter network 1710 is also configured to electrically connect first side 1705-1 and second side 1705-2 at the second frequency. Furthermore, when a position of filter network 1710 changes so that a resonance length and corresponding second frequency of slot antenna 1703 changes, components of filter network 1710 are adjusted so that filter network 1710 also electrically connects first side 1705-1 and second side 1705-2 at the corresponding second frequency

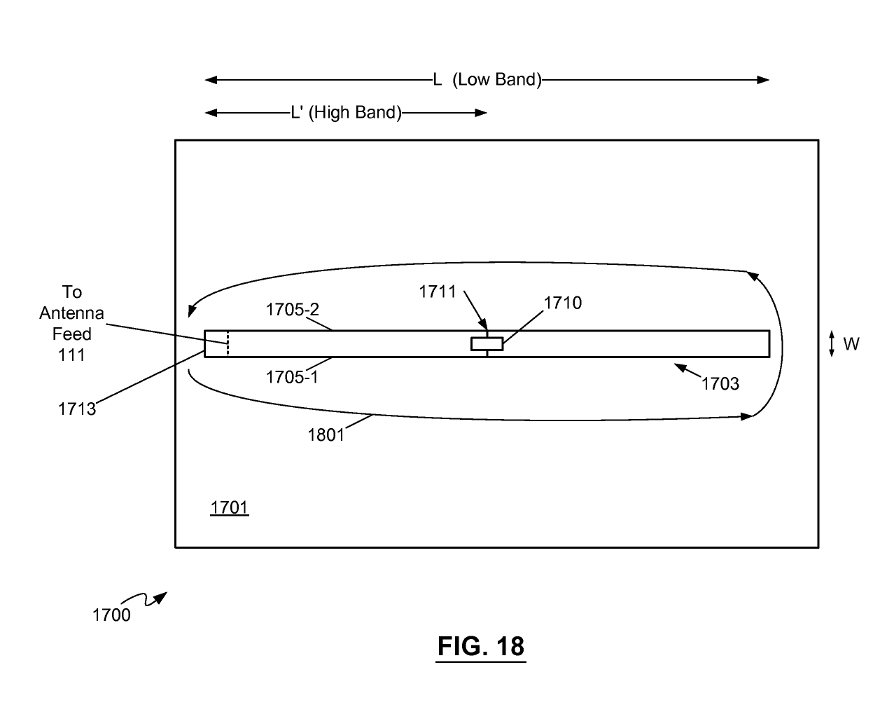

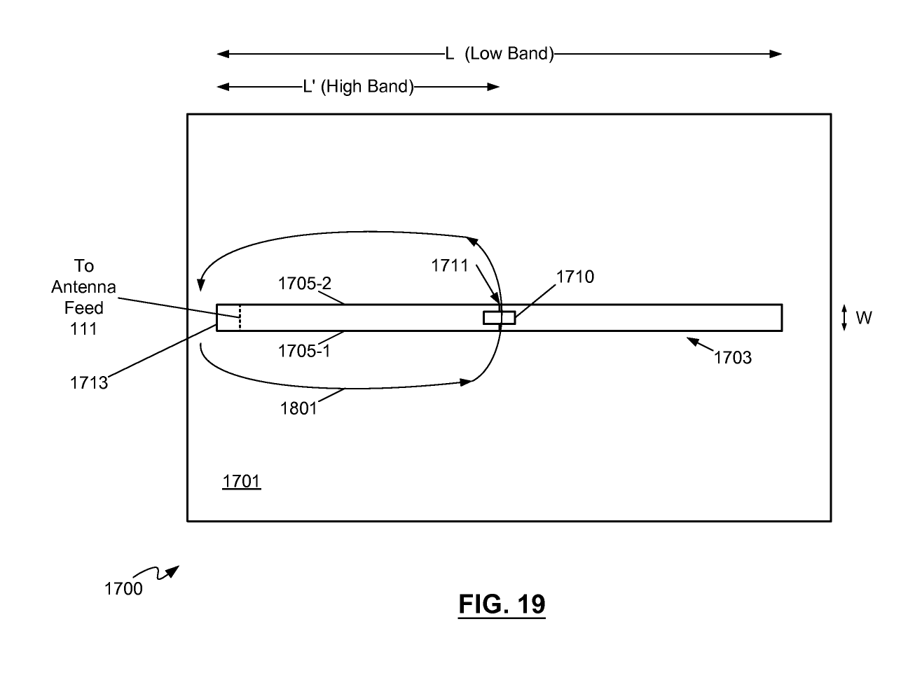

These concepts are illustrated further in FIGS. 18 and 19, each of which is substantially similar to FIG. 17, with like elements having like numbers. In FIG. 18, antenna feed 111 drives antenna 1700 at the first frequency; as filter network 1710 is configured to electrically isolate first side 1705-1 and second side 1705-2 at the first frequency, surface current 1801 driven at the first frequency flows around slot antenna 1703 which, in turn, resonates at the first frequency corresponding to length L.

When the frequency of surface current 1801 is increased from the first frequency to the second frequency, filter network 1710 electrically connects first side 1705-1 and second side 1705-2 so that a short circuit occurs at given position 1711 and, with reference to FIG. 19, surface current 1801 flows across filter network 1710, shortening a path of surface current 1801. In other words, in FIG. 19, antenna feed 111 drives antenna 1700 at the second frequency; as filter network 1710 is configured to electrically connect first side 1705-1 and second side 1705-2 at the second frequency, surface current 1801 driven at the second frequency flows across filter network 1710, and slot antenna 1703, in turn, resonates at the second frequency corresponding to length L′.

Hence, filter network 1710 can be used to effectively shorten slot antenna 1703 at the second frequency. Furthermore, length L′ is chosen so that there is a resonance at the shorter length L′ of slot antenna 1703 at a similar frequency at which filter network 1710 short circuits. Indeed, filter network 1710 is generally located at a position along slot antenna 1703 that corresponds to a desired second frequency that is greater than the first frequency corresponding to length L.

In some implementations, the first resonance can be between about 700 MHz to about 960 MHz, and the second resonance can be between about 1710 to about 2170 MHz, or about 2500 to about 2700. However, other resonance frequencies are within the scope of present implementations. For example, in specific non-limiting implementations described herein, the lower first frequency can be about 700 MHz (e.g. which corresponds to LTE Band 17) and the higher second frequency can be about 850 MHz (e.g. which corresponds to a WCDMA Band). Hence, filter network 1710 is located at a position on slot antenna 1703 corresponding to a resonance at about 850 MHz, and filter network 1710 is configured to electrically connect first side 1705-1 to second side 1705-2 at about 850 MHz. Further a length of slot antenna 1703 corresponds to a resonance at about 700 MHz, and filter network 1710 is further configured to electrically isolate first side 1705-1 and second side 1705-2 at about 700 MHz.

Control of the driving frequency can be performed by one or more of processor 120 and interface 124, as described above.

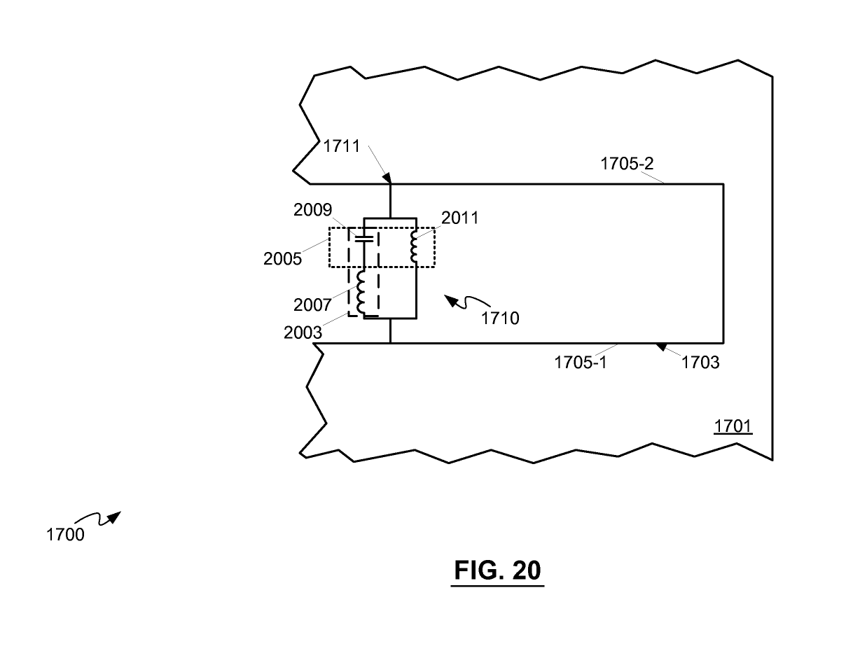

Attention is next directed to FIG. 20, which depicts a portion of antenna 1700 in schematic, including details of filter network 1710. Specifically, in depicted implementations, filter network 1710 comprises a bandpass filter 2005 and a bandstop filter 2003. Each of bandpass filter 2005 and bandstop filter 2003 in filter network 1710 are configured to: electrically isolate first side 1705-1 from second side 1705-2 at the first frequency; and, electrically connect first side 1705-1 and second side 1705-2 at the second frequency. As with filter network 210, use of both a bandpass filter and a bandstop filter sharpens a response of filter network 1710, as compared to use of only a bandpass filter and a bandstop filter to perform the filtering.

As compared to FIG. 2, it is appreciated that an order in which filter network 17010 passes frequencies and stops frequencies, as frequency is being increased, as compared to an order of filter network 210, is reversed because, with slot antennas, as frequency is being increased, a low frequency band is stopped first so that a high frequency band is passed later. With radiating arms, as frequency is being increased, the low frequency band is passed first so that a high frequency band is stopped later.

In depicted implementations, bandpass filter 2005 comprises a first inductor 2011 and a capacitor 2009 connected in parallel between first side 1705-1 and second side 1705-2. Further, bandstop filter 2003 comprises capacitor 2009 and a second inductor 2007 connected in series with capacitor 2009. Values for each of inductors 2007, 2011 and capacitor 2009 can be chosen depending on a desired first frequency and a desired second frequency so that filter network 1710 is configured to: electrically isolate first side 1705-1 from second side 1705-2 at the desired first frequency; and, electrically connect first side 1705-1 and second side 1705-2 at the desired second frequency. In specific non-limiting implementations, second inductor 2007 has an inductance of about 15.8 nH, first inductor 2011 has an inductance of about 7.7 nH, and capacitor 2009 has a capacitance of about 1.8 pF, to produce resonance in ranges of 746 MHz to about 800 MHz, and about 850 MHz to about 960 MHz.

Further, while specific non-limiting implementations of filter network 1710 are depicted, it is appreciated that other combinations of electrical components can be chosen so that filter network 1710 electrically isolates first side 1705-1 and second side 1705-2 at the first frequency and electrically connects first side 1705-1 and second side 1705-2 at the second frequency.

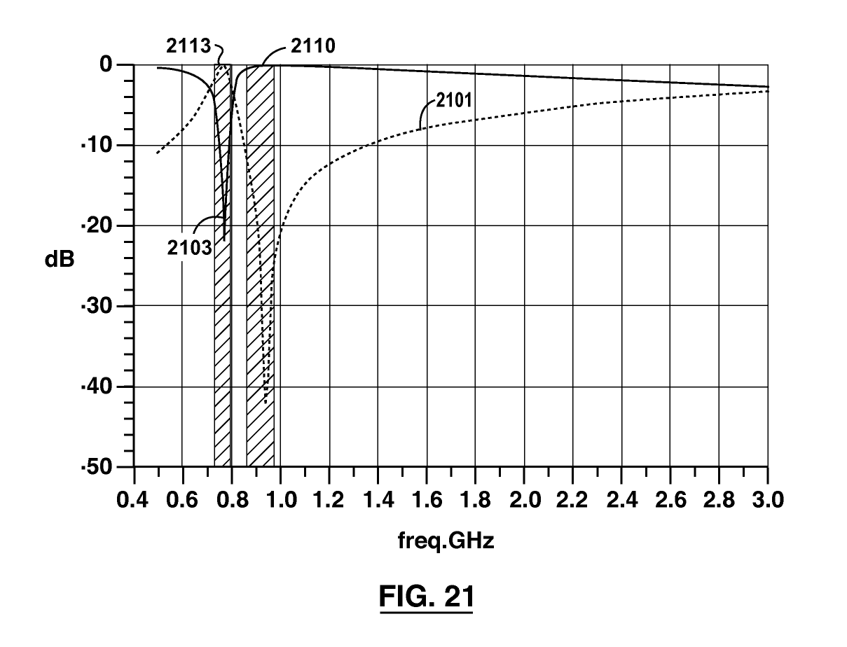

Attention is next directed to FIG. 21 which depicts transmission coefficients 2103 (i.e. S21) and reflection coefficients 2101 (i.e. S11) of specific non-limiting implementations of filter network 1710, where electrical isolation is to occur at, at least about 700 MHz to about 800 MHz (lower frequency), and electrical connection is to occur at, at least about 850 MHz to about 900 MHz (higher frequency); hence, in these implementations, given position 1711 of filter network 1710 would correspond to a resonance at about 850 MHz to about 900 MHz, and slot antenna 1703 would have a length L corresponding to a resonance of about 700 MHz to about 800 MHz. Decibels are depicted on the y-axis and frequency, from about 400 MHz (i.e. 0.4 GHz) to about 3000 MHz (i.e. about 3.0 GHz), is depicted on the x-axis. Transmission coefficients 2103 and reflection coefficients 2101 represent a response of filter network over the depicted frequency range. FIG. 21 also shows a first frequency range 2113 ranging from about 746 MHz to about 800 MHz, and a second frequency range 2110 higher than first frequency range 2113, second frequency range 2110 ranging from about 850 MHz to about 960 MHz.

Transmission coefficients 2103 are very low at first frequency range 2113 and comparatively very high in second frequency range 2110. Hence, filter network 1710 electrically isolates first side 1705-1 to second side 1705-2 in second frequency range 2110.

Similarly, reflection coefficients 2101 are very high at first frequency range 2113 but comparatively very low at second frequency range 2110. Hence, filter network 1710 electrically connects first side 1705-1 and second side 1705-2 in first frequency range 2113.

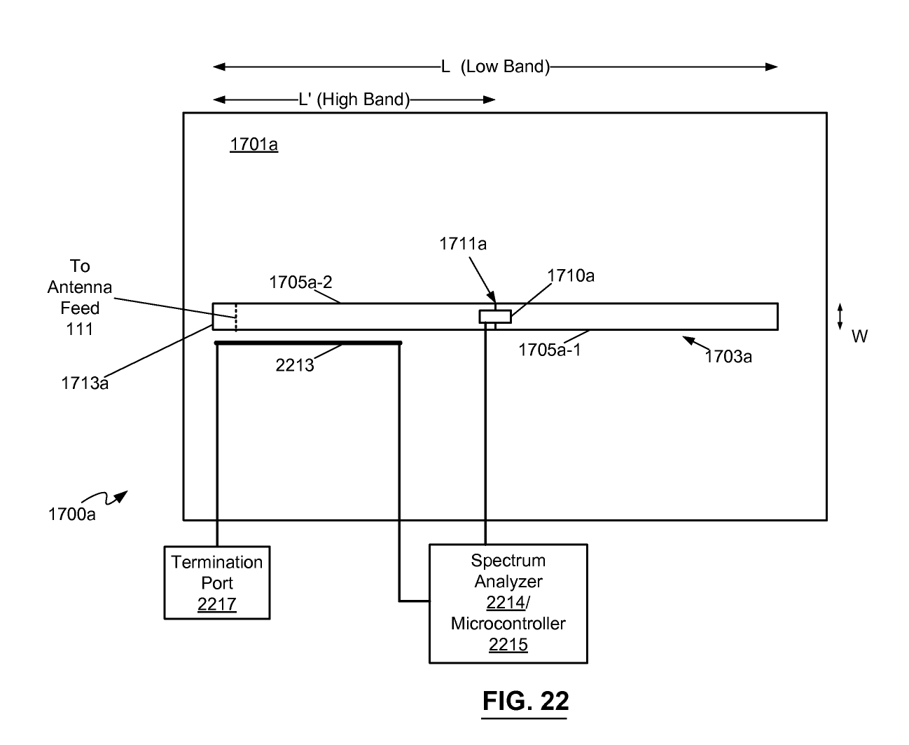

In yet further implementations, a filter network can be tunable. For example, attention is directed to FIG. 22, which is substantially similar to FIG. 17, with like elements having like numbers, however with an “a” appended thereto, which depicts an antenna 1700a, according to non-limiting implementations. Antenna 115 can comprise antenna 1700a. Antenna 1700a comprises: a ground plane 1701a; a slot antenna 1703a in ground plane 1701a, slot antenna 1700a connectable to antenna feed 111, and configured to resonate at a first frequency when surface current from antenna feed 111 flows around slot antenna 1703a, slot antenna 1703a comprising a first side 1705a-1 and a second side 1705a-2 separated by a width W. Antenna 1700a further comprises a filter network 1710a bridging first side 1710a-1 and second side 1710a-2 at a given position 1711a, across width W, from a surface-current-originating end 1713a of slot antenna 1703a. Filter network 1710a is generally configured to: electrically isolate first side 1705a-1 from second side 1705a-2 at the first frequency so that a length, L, of slot antenna 1703a defines a resonant length of slot antenna 1703a at the first frequency; and, electrically connect first side 1705a-1 and second side 1705a-2 at a second frequency higher than the first frequency, so that the surface current flows across filter network 1710a at given position L′, thereby shortening the resonance length of slot antenna 1703a and slot antenna 1703a resonates at the second frequency.

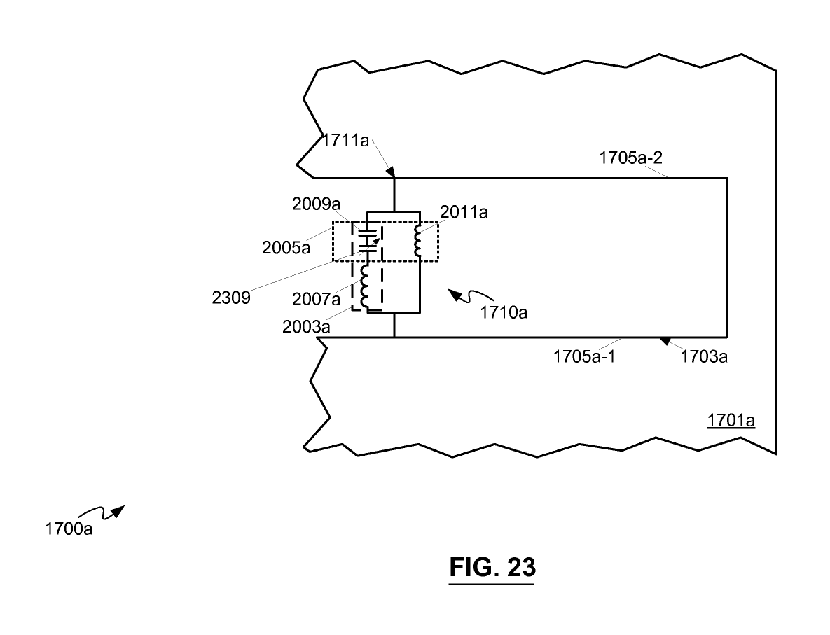

In other words, antenna 1700a is substantially similar to antenna 1700; however filter network 1710a is tunable, as described below with reference to FIG. 23. Specifically, filter network 1710a comprises at least one tunable capacitor for tuning filter network 1710a. To tune filter network 1710a, antenna 1700a further comprises: a directional coupler 2213 capacitively coupled to slot antenna 1703a, for example between surface-current-originating end 1713a and given position 1711a; and, a spectrum analyzer 2214 and microcontroller 2215 in communication with directional coupler 2213 and at least one tunable capacitor of filter network 1710a, spectrum analyzer 2214 configured to determine an input frequency of slot antenna 1703a and microcontroller 2215 configured to tune the at least one tunable capacitor according to the input frequency. Directional coupler 2213 can be terminated at an impedance termination 2217, which provides both a reference impedance, and minimizes reflection from termination port 2217.

Each of directional coupler 2213, spectrum analyzer 2214, microcontroller 2215, and impedance termination 2217 are respectively substantially similar to directional coupler 1213, spectrum analyzer 1214, microcontroller 1215, and impedance termination 1217, and indeed interact in a similar manner as described above.

Attention is next directed to FIG. 23, which depicts a portion of antenna 1700a in schematic, including details of filter network 1710a. FIG. 23 is substantially similar to FIG. 20, with like elements having like numbers, however with and “a” appended thereto. Specifically, in depicted implementations, filter network 1710a comprises a bandpass filter 2005a and a bandstop filter 2003a. Filter network 1710a is configured to: electrically isolate first side 1705a-1 from second side 1705a-2 at the first frequency; and, electrically connect first side 1705a-1 and second side 1705a-2 at the second frequency. As with filter network 210, use of both a bandpass filter and a bandstop filter sharpens a response of filter network 1710a, as compared to use of only a bandpass filter and a bandstop filter to perform the filtering.

In depicted implementations, bandpass filter 2005a comprises a first inductor 2011a and a capacitor 2009a connected in parallel between first side 1705a-1 and second side 1705a-2. Further, bandstop filter 2003a comprises capacitor 2009a and a second inductor 2007a connected in series with capacitor 2009a. Values for each of inductors 2007a, 2011a and capacitor 2009a can be chosen depending on a desired first frequency and a desired second frequency so that filter network 1710a configured to: electrically isolate first side 1705a-1 from second side 1705a-2 at the desired first frequency; and, electrically connect first side 1705a-1 and second side 1705a-2 at the desired second frequency.

In these implementations, one or more of bandpass filter 2005a and bandstop filter 2003a are tunable. For example, one or more of the bandpass filter 2005a and bandstop filter 2003a can comprise at least one tunable capacitor 2309. In depicted implementations, at least one tunable capacitor 2309 is connected in series with capacitor 2009 (and second inductor 2007a). While not depicted, it is appreciated that at least one tunable capacitor 2309 is controlled by microcontroller 2215 (i.e. microcontroller 2215 is in communication and/or connected to at least one tunable capacitor 2309, similar to microcontroller 1215 controlling tunable capacitors 1209, 1211).

Further, while specific non-limiting implementations of filter network 1710a are depicted, it is appreciated that other combinations of electrical components can be chosen so that filter network 1710a electrically isolates first side 1705a-1 and second side 1705a-2 at the first frequency and electrically connects first side 1705a-1 and second side 1705a-2 at the second frequency.

In other words, directional coupler 2213 couples to slot antenna 1703a and measures and/or samples an input frequency thereof; spectrum analyzer 2214 receives a signal from directional coupler 2213, and determines the input frequency of slot antenna 1703a from the signal, i.e. the input frequency received from antenna feed 111. For example, the input frequency can comprise the first frequency or the second frequency. The input frequency is determined, and spectrum analyzer 2214 communicates the input frequency to microcontroller 2215, which can responsively control at least one tunable capacitor 2309 accordingly via an output to tunable capacitor 2309.

The capacitance values to which tunable capacitor 2309 can be tuned can based on a lookup table, and the like, stored at microcontroller 2215. For example, tunable capacitor 2309 can be tuned to a first value when the input frequency is about the first frequency, and tunable capacitor 2309 can be tuned to a second value when the input frequency is about the second frequency. The first value and second value can be stored in a lookup table, and the like, in respective association with each of the first frequency and the second frequency. Further, if either of the first frequency or the second frequency drifts due to changes in input impedance at antenna 1700a, for example, at least one tunable capacitor 2309 can be tuned in a feedback loop with directional coupler 2213, spectrum analyzer 2214 and microcontroller 2215 to maintain the first frequency or the second frequency

In FIG. 22, it is assumed that spectrum analyzer 2214 and microcontroller 2215 are combined into one device, however, in other implementations, spectrum analyzer 2214 and microcontroller 2215 can be separate devices in communication with each other, microcontroller 2215 receiving the measured input frequency from spectrum analyzer 2214.

While not depicted, antenna 1700a can optionally comprise one or more tuning stubs (i.e. tuning stub slots) to provide additional tuning capability, similar to tuning stubs 1217-1, 1217-2.

Further while only one tunable capacitor 2309 is depicted in FIG. 23, in other implementations, filter network 1710a can comprise more than one tunable capacitor and/or at least one tunable inductor.

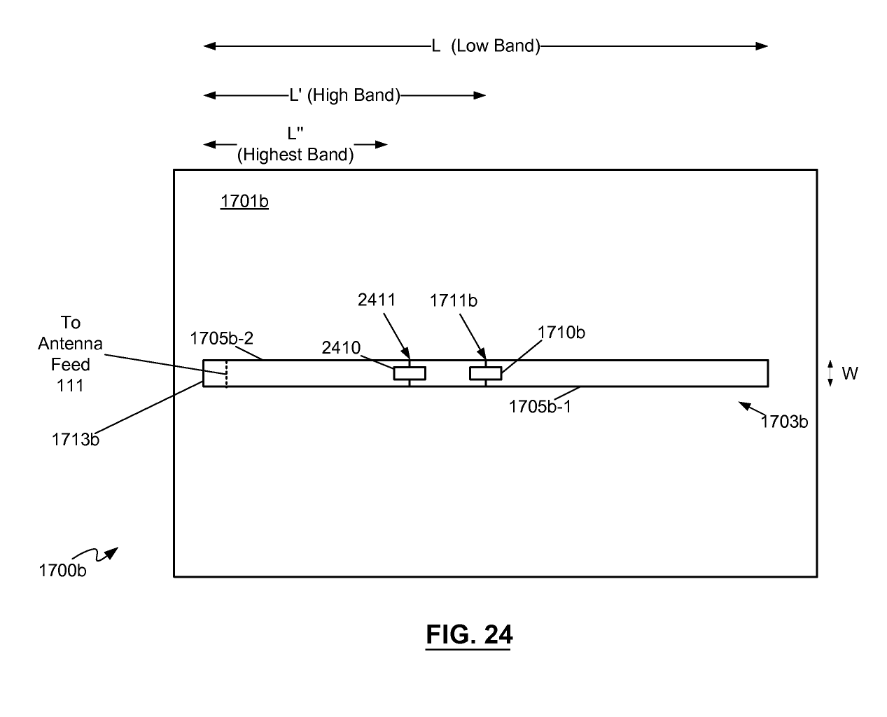

In yet further implementations, more than one filter network can be incorporated into a slot antenna. For example, attention is directed to FIG. 24, which is substantially similar to FIG. 17, with like elements having like numbers, however with a “b” appended thereto, which depicts an antenna 1700b, according to non-limiting implementations. Antenna 115 can comprise antenna 1700b. Antenna 1700b comprises: a ground plane 1701b; a slot antenna 1703b in ground plane 1701b, slot antenna 1700b connectable to antenna feed 111, and configured to resonate at a first frequency when surface current from antenna feed 111 flows around slot antenna 1703b, slot antenna 1703b comprising a first side 1705b-1 and a second side 1705b-2 separated by a width W. Antenna 1700b further comprises a filter network 1710b bridging first side 1710b-1 and second side 1710b-2 at a given position 1711b, across width W, from a surface-current-originating end 1713b of slot antenna 1703b. Filter network 1710b is generally configured to: electrically isolate first side 1705b-1 from second side 1705b-2 at the first frequency so that a length, L, of slot antenna 1703b defines a resonant length of slot antenna 1703b at the first frequency; and, electrically connect first side 1705b-1 and second side 1705b-2 at a second frequency higher than the first frequency, so that the surface current flows across filter network 1710b at given position L′ (i.e. High Band), thereby shortening the resonance length of slot antenna 1703b and slot antenna 1703b resonates at the second frequency.

Hence, antenna 1700b is substantially similar to antenna 1700; however, antenna 1700b further comprises at least a second filter network 2410 bridging first side 1705b-1 and second side 1705b-2 at a second given position 2411 along length L, across width W, second given position 2411 between given position 1711b and surface-current-originating end 1713b of slot antenna 1703b, second filter network 2410 configured to: electrically isolate first side 1705b-1 from second side 1705b-2 at the first frequency and the second frequency; and, electrically connect first side 1705b-1 to second side 1705b-2 at a third frequency higher than the second frequency, so that the surface current flows across filter network 1710b at second given position 2411, thereby further shortening the resonance length of slot antenna 1703b so that slot antenna 1703b resonates at the third frequency.

Filter network 1710b is further configured to electrically isolate first side 1705b-1 from second side 1705b-2 at the third frequency so that the surface current flows across second filter network 2410 at the third frequency but not across filter network 1710b at the third frequency.

As with filter networks 1710, 1710a, 1710b, the frequency at which second filter network 2410 electrically connects first side 1705b-1 to second side 1705b-2 is a similar frequency associated with a resonance length of a distance L″ (also labelled “Highest Band” in FIG. 24) from surface-current-originating end 1713b and given position 2411.

Hence, antenna 1700b is generally configured to resonate at three different frequencies: a first frequency associated with length L (“Low Band”); a second frequency associated with length L′ (“High Band”) shorter than length L, the second frequency hence higher than the first frequency; and a third frequency associated with length L″ (“Highest Band”) shorter than length L′, the third frequency hence higher than the second frequency.

Further, while not depicted, each of filter networks 1710b, 2410 can comprise a respective bandpass filter and a respective bandstop filter each respectively similar to bandpass filter 2005 and bandstop filter 2003, each configured to: electrically isolate first side 1705b-1 from second side 1705b-2 at the first frequency; and, electrically connect first side 1705b-1 and second side 1705b-2 at respective frequencies higher than the first frequency. Further, the bandpass filter and bandstop filter of filter network 1710b is further configured to electrically isolate first side 1705b-1 from second side 1705b-2 at a frequency at which second filter network 2410 electrically connects first side 1705b-1 to second side 1705b-2.

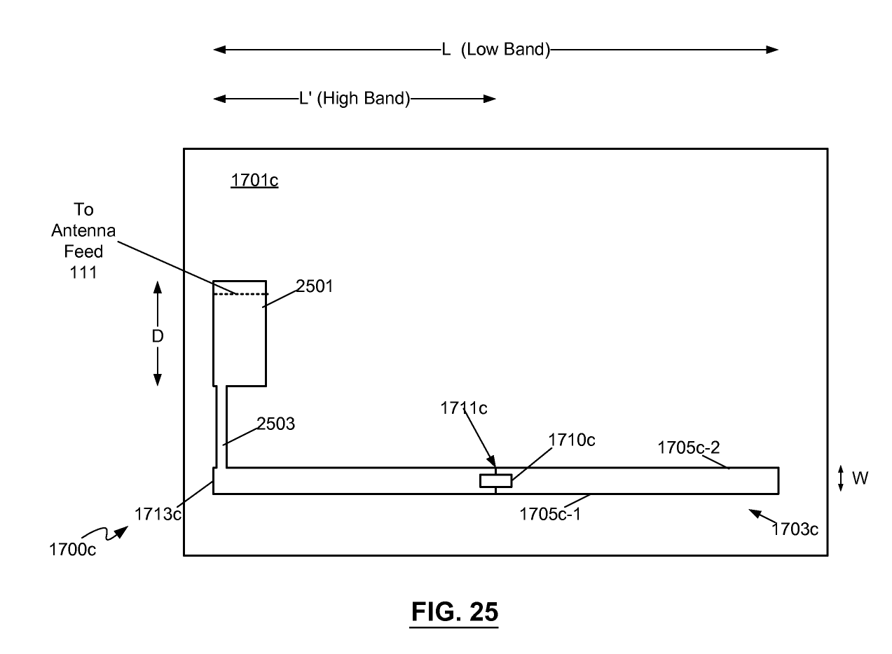

In yet further implementations antennas as described herein can be further configured to include further slot antennas with resonances at yet further frequencies. For example, attention is directed to FIG. 25, which is substantially similar to FIG. 17, with like elements having like numbers, however with a “c” appended thereto, which depicts an antenna 1700c, according to non-limiting implementations. Antenna 115 can comprise antenna 1700c. Antenna 1700c comprises: a ground plane 1701c; a slot antenna 1703c in ground plane 1701c, slot antenna 1700c connectable to antenna feed 111, and configured to resonate at a first frequency when surface current from antenna feed 111 flows around slot antenna 1703c, slot antenna 1703c comprising a first side 1705c-1 and a second side 1705c-2 separated by a width W. Antenna 1700c further comprises a filter network 1710c bridging first side 1710c-1 and second side 1710c-2 at a given position 1711c, across width W, from a surface-current-originating end 1713c of slot antenna 1703c. Filter network 1710c is generally configured to: electrically isolate first side 1705c-1 from second side 1705c-2 at the first frequency so that a length, L, of slot antenna 1703c defines a resonant length of slot antenna 1703c at the first frequency; and, electrically connect first side 1705c-1 and second side 1705c-2 at a second frequency higher than the first frequency, so that the surface current flows across filter network 1710c at given position L′ (i.e. High Band), thereby shortening the resonance length of slot antenna 1703c and slot antenna 1703c resonates at the second frequency.

Further, while not depicted, filter networks 1710c can comprise a respective bandpass filter and a respective bandstop filter each respectively similar to bandpass filter 2005 and bandstop filter 2003, each configured to: electrically isolate first side 1705c-1 from second side 1705c-2 at the first frequency; and, electrically connect first side 1705c-1 and second side 1705c-2 at the second frequency higher than the first frequency.

Hence, antenna 1700c is substantially similar to antenna 1700; however, antenna 1700c further comprises one or more second slot antennas 2501 in communication with slot antenna 1703c at surface-current-originating end 1713c of slot antenna 1703c, for example via a further slot 2503, one or more second slot antennas 2501 configured to resonate at one or more third frequencies different from the first frequency and the second frequency. In some implementations further slot 2503 can also resonate.

In other words, slot antennas 1703c, 2501 can be connected in series, each having different resonant lengths and/or radiating properties, such that antenna 1700c comprise a plurality of resonances. In yet further implementations, one or more radiating arms, similar or different from radiating arms 201, 202, connectable to antenna feed 111, and which can include or not include filter networks similar to filter network 210, can be incorporated into antenna 1700c to provide yet further resonances for antenna 1700c.

Furthermore, while FIG. 25 depicts second slot antenna 2501 as being connectable to antenna feed 111 (i.e. slot antenna 1703c is connectable to antenna feed 111 via second slot antenna 2501), in other implementations, a connection to antenna feed 111 is located at slot antenna 1703c.

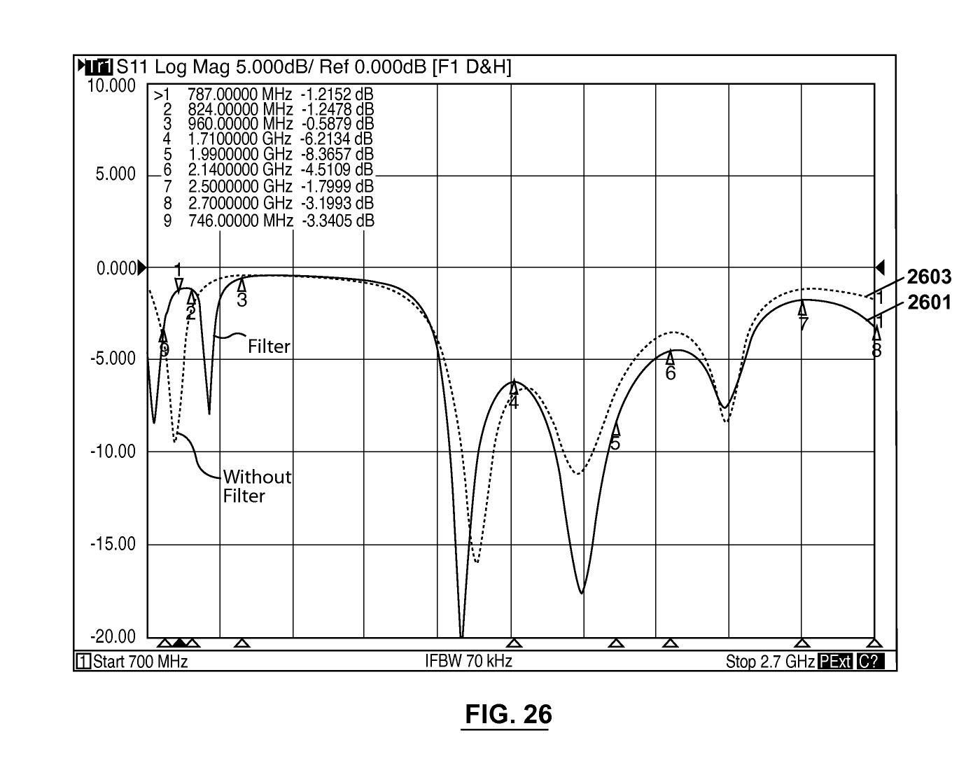

Attention is next directed to FIG. 26 which depicts two return-loss curves 2601, 2603 generated using simulation software: a return-loss curve 2601 of antenna 1700c (also labelled “Filter”); and a return-loss curve 2603 of similar antenna without filter network 1710c (also labelled “Without Filter”). Return-loss curves 2601, 2603 are depicted over a frequency range from about 700 MHz to about 2700 MHz (i.e. about 2.7 GHz).

In these implementations, antenna 1700c is configured for resonances at about 700 MHz and about 850 MHz, as well as resonances at higher frequencies due to second slot antenna 2501, and harmonics thereof, for example resonances that can correspond to LTE bands, WCDMA bands and the like.

In any event, return-loss curve 2603 shows that an antenna without filter network 1710c has a resonance at about 787 MHz, and additional resonances at higher frequencies due to a slot antenna similar to second slot antenna 2501 and/or harmonics thereof. In contrast, return-loss curve 2601 shows that antenna 1700c has resonances at about 700 MHz and about 850 MHz (e.g. supporting LTE Band 17 and WCDMA Band 5, simultaneously)): the impedance of antenna 1700c is high enough so that the nominal resonance at about 787 MHz is split into two resonance at about 700 MHz and about 850 MHz. Furthermore, filter network 1710c has almost no effect on the higher band resonances; indeed, return-loss of the higher band resonances appears to be improved at most bands.

In any event, slot antennas with a filter network that can include a combined bandpass/bandstop filter network, are described herein that can replace a plurality of antennas at a mobile electronic device. The specific resonance bands of the slot antennas described herein can be varied by varying the dimensions of components of the slot antennas to advantageously align the bands with bands used by service providers, and by providing a filter network, that can include a bandpass/bandstop filter network, that bridges long sides of the antennas. In some implementations, capacitance and/or inductance of one or more of bandstop filters and bandpass filters can be tuned. Further, the present antennas obviate the need to use different antennas for different bands in different regions.

A portion of the disclosure of this patent document contains material which is subject to copyright protection. The copyright owner has no objection to the facsimile reproduction by any one of the patent document or patent disclosure, as it appears in the Patent and Trademark Office patent file or records, but otherwise reserves all copyrights whatsoever.

Persons skilled in the art will appreciate that there are yet more alternative implementations and modifications possible, and that the above examples are only illustrations of one or more implementations. The scope, therefore, is only to be limited by the claims appended here.

What is claimed is:

1. An antenna comprising:
a ground plane;
a slot antenna in the ground plane, the slot antenna connectable to an antenna feed, and configured to resonate at a first frequency when surface current from the antenna feed flows around the slot antenna, the slot antenna comprising a first side and a second side separated by a width; and,
a filter network bridging the first side and the second side, across the width, at a given position from a surface-current-originating end of slot antenna, the filter network configured to:
electrically isolate the first side from the second side at the first frequency so that a length of the slot antenna defines a resonant length of the slot antenna at the first frequency; and,
electrically connect the first side to the second side at a second frequency higher than the first frequency, so that the surface current flows across the filter network at the given position, thereby shortening the resonance length of the slot antenna and the slot antenna resonates at the second frequency.

2. The antenna of claim 1, wherein the length of the slot antenna corresponds to resonance at the first frequency.

3. The antenna of claim 1, wherein a distance between the given position and the surface-current-originating end of the slot antenna corresponds to resonance at the second frequency.

4. The antenna of claim 1, wherein the first frequency is one or more of at about 700 MHz and between about 700 MHz to about 960 MHz.

5. The antenna of claim 1, wherein the second frequency is at about 850 MHz, between about 1710 to about 2170 MHz, or about 2500 to about 2700.

6. The antenna of claim 1, wherein the filter network comprises a bandpass filter and a bandstop filter.

7. The antenna of claim 6, wherein the bandpass filter comprises a first inductor and a capacitor connected in parallel between the first side and the second side.

8. The antenna of claim 7, wherein the bandstop filter comprises the capacitor and a second inductor connected in series with the capacitor.

9. The antenna of claim 6, wherein one or more of the bandstop filter and the bandpass filter are tunable.

10. The antenna of claim 9, wherein one or more of the bandpass filter and the bandstop filter comprise at least one tunable capacitor.

11. The antenna of claim 10, further comprising:
a directional coupler capacitively coupled to the slot antenna; and,
a spectrum analyzer and microcontroller in communication with the directional coupler and the at least one tunable capacitor, the spectrum analyzer configured to determine an input frequency of the slot antenna and the microcontroller configured to tune the at least one tunable capacitor according to the input frequency.

12. The antenna of claim 1, further comprising:
at least a second filter network bridging the first side and the second side, across the width, at a second given position along the length, the second given position between the given position and the surface-current-originating end of the slot antenna, the second filter network configured to:
electrically isolate the first side from the second side at the first frequency and the second frequency; and,
electrically connect the first side to the second side at a third frequency higher than the second frequency, so that the surface current flows across the second filter network at the second given position, thereby further shortening the resonance length of the slot antenna so that the slot antenna resonates at the third frequency.

13. The antenna of claim 12, wherein the filter network is further configured to electrically isolate the first side from the second side at the third frequency.

14. The antenna of claim 1, further comprising one or more second slot antennas in communication with the slot antenna at surface-current-originating end of the slot antenna, the one or more second slot antennas configured to resonate at one or more third frequencies different from the first frequency and the second frequency.

15. The antenna of claim 14, wherein the one or more second slot antennas has a different width from the slot antenna.
